(19) United States
(12) Patent Application Publication
(10) Pub. No.: US 2025/0105349 A1
(43) Pub. Date: Mar. 27, 2025

(54) ION CONDUCTIVE SOLID AND ALL-SOLID-STATE BATTERY

(71) Applicant: CANON OPTRON, INC., Ibaraki (JP)

(72) Inventors: Saori FUJIKURA, Tochigi (JP); Noriko SAKAMOTO, Tochigi (JP); Takeshi KOBAYASHI, Ibaraki (JP); Yoshitaka SHIBA, Tochigi (JP)

(21) Appl. No.: 18/974,994

(22) Filed: Dec. 10, 2024

Related U.S. Application Data
(63) Continuation of application No. PCT/JP2023/014777, filed on Apr. 11, 2023.

(30) Foreign Application Priority Data
Aug. 8, 2022 (JP) 2022-126420

(51) Int. Cl. H01M 10/0562

(52) U.S. Cl. CPC H01M 10/0562

(57) ABSTRACT

An ion conductive solid comprising an oxide represented by a general formula: Li_{6+a-c-2d}X_{1-a-b-c-d}M1ₐM2_{b}M3_{c}M4_{d}B₃O₉, where, in formula, X is at least one metal element selected from a group consisting of Lu, Ho, Er, and Tm, M1 is at least one metal element selected from a group consisting of Mg, Mn, Zn, Ni, Ca, Sr, and Ba, M2 is at least one metal element selected from a group consisting of La, Pr, Nd, Sm, Eu, Gd, Tb, Dy, Ho, Er, Tm, Lu, In, Fe, and Sc, M3 is at least one metal element selected from a group consisting of Zr, Ce, Hf, Sn, and Ti, M4 is at least one metal element selected from a group consisting of Nb and Ta, and a, b, c, and d are specific real numbers, provided that a case in which X and M2 are the same metal elements is excluded.

### CROSS REFERENCE TO RELATED APPLICATIONS

This application is a Continuation of PCT International Application No. PCT/JP2023/014777, filed on Apr. 11, 2023, which is claiming priority of Japanese Patent Application No. 2022-126420, filed on Aug. 8, 2022, all of which are hereby expressly incorporated by reference into the present application.

### BACKGROUND OF THE INVENTION

### Field of the Invention

The present disclosure relates to an ion conductive solid and an all-solid-state battery.

### Description of the Related Art

Conventionally, light-weight and high-capacity lithium ion secondary batteries have been included in mobile devices such as smartphones and notebook computers, and transport devices such as electric vehicles and hybrid electric vehicles.

However, since liquids containing combustible solvents have been used as electrolytes in conventional lithium ion secondary batteries, the leakage of the combustible solvents and ignition in the case of the short circuit of the batteries have been feared. Thus, secondary batteries using, as electrolytes, ion conductive solids different from the liquid electrolytes, to secure safety, have received attention in recent years. Such secondary batteries have been called all-solid-state batteries.

Solid electrolytes such as oxide-based solid electrolytes and sulfide-based solid electrolytes have been widely known as the electrolytes used in the all-solid-state batteries. Among them, the oxide-based solid electrolytes do not react with moisture in the atmosphere, and do not generate hydrogen sulfide. Thus, the oxide-based solid electrolytes are safer than the sulfide-based solid electrolytes.

Such an all-solid-state battery includes: a cathode comprising a cathode active material; an anode comprising an anode active material; an electrolyte that is placed between the cathode and the anode, and includes an ion conductive solid; and, if necessary, a current collector (the cathode active material and the anode active material are collectively referred to as “electrode active material”). In a case in which the all-solid-state battery is manufactured using an oxide-based solid electrolyte, heat treatment is performed to reduce the contact resistance between the particles of an oxide-based material included in the solid electrolyte. However, in a conventional oxide-based solid electrolyte, a high temperature of 900° C. or more is required in the heat treatment, and the solid electrolyte and the electrode active material may therefore react to form a high-resistance phase. The high-resistance phase may lead to a decrease in the ionic conductivity of the ion conductive solid and, in turn, to a decrease in the output of the all-solid-state battery.

Examples of oxide-based solid electrolytes that can be produced by heat treatment at a temperature of less than 900° C. include Li₂₊ₓC₁₋ₓBₓO₃ (Solid State Ionic 288 (2016) 248-252).

Moreover, it is disclosed that characteristics can be improved by allowing the Li₂₊ₓC₁₋ₓBₓO₃ described above to contain a specific element at a specific ratio (Japanese Patent No. 6948676).

### SUMMARY OF THE INVENTION

The present disclosure provides: an ion conductive solid that can be produced by heat treatment at low temperature and has a high ion conductivity; and an all-solid-state battery comprising the ion conductive solid.

An ion conductive solid of the present disclosure is an ion conductive solid comprising an oxide represented by a general formula: Li_{6+a-c-2d}X_{1-a-b-c-d} M1ₐM2_{b}M3_{c}M4_{d}B₃O₉
where, in the formula, X is at least one metal element selected from a group consisting of Lu, Ho, Er, and Tm,
M1 is at least one metal element selected from a group consisting of Mg, Mn, Zn, Ni, Ca, Sr, and Ba,
M2 is at least one metal element selected from a group consisting of La, Pr, Nd, Sm, Eu, Gd, Tb, Dy, Ho, Er, Tm, Lu, In, Fe, and Sc,
M3 is at least one metal element selected from a group consisting of Zr, Ce, Hf, Sn, and Ti,
M4 is at least one metal element selected from a group consisting of Nb and Ta, and a is 0.000≤a≤0.800, b is 0.000≤b≤0.900, c is 0.000≤c≤0.800, d is 0.000≤d≤0.800, and a, b, c, and d are real numbers satisfying 0.000≤a+b+c+d<1.000, provided that a case in which X and M2 are the same metal elements is excluded.

An all-solid-state battery of the present disclosure is an all-solid-state battery comprising at least:
a cathode;
an anode; and
an electrolyte,
wherein at least one selected from a group consisting of the cathode, the anode, and the electrolyte comprises the ion conductive solid of the present disclosure.

In accordance with one aspect of the present disclosure, there can be obtained: an ion conductive solid that can be produced by heat treatment at low temperature and has a high ion conductivity; and an all-solid-state battery comprising the ion conductive solid. Further features of the present invention will become apparent from the following description of exemplary embodiments.

### DESCRIPTION OF THE EMBODIMENTS

In the present disclosure, a description of “XX or more and YY or less” or “XX to YY” representing a numerical range means a numerical range including lower and upper limits which are end points, unless otherwise specified. When numerical ranges are described in a stepwise manner, the upper and lower limits of each numerical range may be optionally combined.

In the present disclosure, “solid” refers to the state of matter having certain shape and volume, in the three states of matter. A powdery state is included in “solid”.

An ion conductive solid of the present disclosure is an ion conductive solid comprising an oxide represented by a general formula: Li_{6+a-c-2d}X_{1-a-b-c-d}M1ₐM2_{b}M3_{c}M4_{d}B₃O₉.

In the formula, X is at least one metal element selected from a group consisting of Lu, Ho, Er, and Tm,
M1 is at least one metal element selected from a group consisting of Mg, Mn, Zn, Ni, Ca, Sr, and Ba,
M2 is at least one metal element selected from a group consisting of La, Pr, Nd, Sm, Eu, Gd, Tb, Dy, Ho, Er, Tm, Lu, In, Fe, and Sc,
M3 is at least one metal element selected from a group consisting of Zr, Ce, Hf, Sn, and Ti,
M4 is at least one metal element selected from a group consisting of Nb and Ta, and a is 0.000≤a≤0.800, b is 0.000≤b≤0.900, c is 0.000≤c≤0.800, d is 0.000≤d≤0.800, and a, b, c, and d are real numbers satisfying 0.000≤a+b+c+d<1.000, provided that a case in which X and M2 are the same metal elements is excluded.

“A case in which X and M2 are the same metal elements is excluded” refers to a case
in which, when X is Lu, M2 is at least one metal element selected from the group consisting of La, Pr, Nd, Sm, Eu, Gd, Tb, Dy, Ho, Er, Tm, In, Fe, and Sc,
in which, when X is Ho, M2 is at least one metal element selected from the group consisting of La, Pr, Nd, Sm, Eu, Gd, Tb, Dy, Er, Tm, Lu, In, Fe, and Sc,
in which, when X is Er, M2 is at least one metal element selected from the group consisting of La, Pr, Nd, Sm, Eu, Gd, Tb, Dy, Ho, Tm, Lu, In, Fe, and Sc, or
in which, when X is Tm, M2 is at least one metal element selected from the group consisting of La, Pr, Nd, Sm, Eu, Gd, Tb, Dy, Ho, Er, Lu, In, Fe, and Sc.

The reason why the ion conductive solid comprising the oxide represented by the general formula above is improved in ionic conductivity is presumed by the present inventors as follows.

Substitution of Y in Li₆YB₃O₉ listed in Comparative Example 1 in Japanese Patent No. 6948676 with at least one selected from the group consisting of Lu, Ho, Er, and Tm being metal elements having smaller ionic radii than Y results in decreases in lattice constant and lattice volume. As a result, Li⁺ is allowed to move easily, and therefore, the ionic conductivity is improved.

In Japanese Patent No. 6948676, Y being a trivalent metal element is partially substituted with a tetra- to pentavalent metal element, namely, substitution between elements different in valency provides adjustment of the balance of charge, and improvement in ion conductive properties.

Such use of a metal element having an appropriate ionic radius as a metal element X, instead of Y, results in decreases in lattice constant and lattice volume. As a result, Li⁺ is allowed to more easily move, and therefore the ionic conductivity is further improved. Moreover, combination use with substitution between elements different in valency also corresponds to a preferred aspect.

X preferably has an ionic radius of 0.900 to 1.017 Å, more preferably 0.920 to 1.015 Å, still more preferably 0.940 to 1.015 Å, and particularly preferably 0.975 to 1.015 Å. The above-described range results in decreases in lattice constant and lattice volume. As a result, Li⁺ is allowed to move easily, and therefore, the ionic conductivity is improved. An ionic radius of less than 0.900 Å cannot provide an objective monoclinic structure, and therefore an ion conductive solid cannot be achieved.

The values described in Acta Crystallographica Section A 32 (1976) 751 can be used as the values of the ionic radii. For example, the ionic radius of Y³⁺ is 1.019 Å, the ionic radius of Lu³⁺ is 0.977 Å, the ionic radius of Ho³⁺ is 1.015 Å, the ionic radius of Er³⁺ is 1.004 Å, and the ionic radius of Tm³⁺ is 0.994 Å.

The ion conductive solid of the present disclosure preferably includes a monoclinic crystal structure.

The ion conductive solid of the present disclosure preferably has a volume mean particle diameter of 0.1 μm or more and 28.0 μm or less, more preferably 0.2 m or more and 26.0 μm or less, still more preferably 0.3 μm or more and 20.0 μm or less, even more preferably 0.3 μm or more and 15.0 μm or less, and still even more preferably 0.5 μm or more and 10.0 μm or less. The above-described range results in a reduction in grain-boundary resistivity in an ion conductive solid, and in more improvement in ionic conductivity.

The volume mean particle diameter of the ion conductive solid can be controlled by pulverization or classification.

In the general formula above, a is a real number satisfying 0.000≤a≤0.800.
a is 0.000≤a≤0.800, preferably 0.000≤a≤0.600, more preferably 0.000≤a≤0.400, still more preferably 0.000≤a≤0.100, particularly preferably 0.000≤a K 0.050, and most preferably 0.000≤a≤0.030.

In the general formula above, b is a real number satisfying 0.000≤b≤0.900.
b is 0.000≤b≤0.900, preferably 0.000≤b≤0.600, more preferably 0.000≤b≤0.500, still more preferably 0.000≤b≤0.400, even more preferably 0.000≤b≤0.100, particularly preferably 0.000≤b≤0.050, and most preferably 0.000≤b≤0.030.

In the general formula above, c is a real number satisfying 0.000≤c≤0.800.
c is 0.000≤c≤0.800, preferably 0.000≤c≤0.600, more preferably 0.000≤c≤0.400, still more preferably 0.000≤c≤0.150, even more preferably 0.000≤c≤0.100, particularly preferably 0.000≤c≤0.050, and most preferably 0.000≤c≤0.030. C may be preferably 0.050≤c≤0.200, more preferably 0.080≤c≤0.150.

In the general formula above, d is a real number satisfying 0.000≤d≤0.800.
d is 0.000≤d≤0.800, preferably 0.000≤d≤0.600, more preferably 0.000≤d≤0.400, still more preferably 0.000≤d≤0.100, particularly preferably 0.000≤d≤0.050, and most preferably 0.010≤d≤0.030.

In the general formula above, a+b+c+d is a real number satisfying 0.000≤a+b+c+d<1.000.
a+b+c+d is 0.000≤a+b+c+d≤1.000, preferably 0.000≤a+b+c+d<0.900, more preferably 0.000≤a+b+c+d≤0.800, still more preferably 0.000≤a+b+c+d<0.700, even more preferably 0.000≤a+b+c+d≤0.600, especially preferably 0.010≤a+b+c+d<0.500, particularly preferably 0.050≤a+b+c+d<0.300, and most preferably 0.080≤a+b+c+d<0.250.

In X_{1-a-b-c-d}, the 1−a−b−c−d is preferably 0.300≤1−a−b−c−d, more preferably 0.500≤1−a−b−c−d, still more preferably 0.700≤1−a−b−c−d, and even more preferably 0.750≤1−a−b−c−d. The upper limit is not particularly limited, and is preferably less than 1.000, 0.950 or less, or 0.900 or less. Examples preferably include respective ranges of 0.300≤1−a−b−c−d≤1.000, 0.500≤1−a−b−c−d≤0.950, and 0.700≤1−a−b−c−d≤0.900.

The ion conductive solid of the present disclosure may be allowed to be, for example, the following embodiments, but is not limited to the embodiments.

(1)

It is acceptable that a is 0.010≤a≤0.100, b is 0.000≤b≤0.200, c is 0.000≤c≤0.200, d is 0.010≤d≤0.100, and a, b, c, and d satisfy 0.010≤a+b+c+d<0.300.

(2)

It is acceptable that a is 0.010≤a≤0.030, b is 0.030≤b≤0.100, c is 0.010≤c≤0.030, d is 0.010≤d≤0.030, and a, b, c, and d satisfy 0.050≤a+b+c+d<0.160.

(3)

It is acceptable that a is 0.000≤a≤0.010, b is 0.000≤b≤0.100, c is 0.050≤c≤0.150, d is 0.000≤d≤0.030, and a, b, c, and d satisfy 0.050≤a+b+c+d<0.250.

M1, M2, M3, and M4 in the general formula above are optionally included in the formula. In other words, at least one of a, b, c, and d may be zero. It means that one of a, b, c and d may be zero, more than one may be zero, or all may be zero.

In the general formula above, M1 is at least one metal element selected from the group consisting of Mg, Mn, Zn, Ni, Ca, Sr, and Ba.

M1 is at least one selected from the group consisting of Mg, Mn, Zn, Ni, Ca, Sr, and Ba, preferably at least one selected from the group consisting of Mg, Zn, Ca, Sr, and Ba, and more preferably at least one selected from the group consisting of Mg, Ca, and Sr.

In the general formula above, M2 is at least one metal element selected from the group consisting of La, Pr, Nd, Sm, Eu, Gd, Tb, Dy, Ho, Er, Tm, Lu, In, Fe, and Sc.

M2 is at least one selected from the group consisting of La, Pr, Nd, Sm, Eu, Gd, Tb, Dy, Ho, Er, Tm, Lu, In, Fe, and Sc, preferably at least one selected from the group consisting of La, Eu, Gd, Tb, Dy, Lu, In, and Fe, and more preferably at least one selected from the group consisting of Gd, Dy, Lu, In, and Fe. M2 may be at least one selected from the group consisting of La, Pr, Nd, Sm, Eu, Gd, Tb, Dy, In, Fe, and Sc.

In the general formula above, M3 is at least one metal element selected from the group consisting of Zr, Ce, Hf, Sn, and Ti.

M3 is at least one selected from the group consisting of Zr, Ce, Hf, Sn, and Ti, preferably at least one selected from the group consisting of Zr, Ce, Hf, and Sn, and more preferably at least one selected from the group consisting of Zr, Ce, and Hf.

In the general formula above, M4 is at least one metal element selected from the group consisting of Nb and Ta.

M4 is at least one selected from the group consisting of Nb and Ta, and preferably Nb.

Furthermore, substitution of some of X elements which are trivalent metal elements by using specific elements M1, M2, M3, and M4 in the ranges of specific rates causes adjustment of the balance of charge by substitution between elements different in valency. Thus, a state in which Li⁺ in the crystal lattice is deficient occurs. Li⁺ neighboring on a place in which Li⁺ is deficient moves to fill the place, and therefore, the ionic conductivity is improved.

A method of producing the ion conductive solid of the present disclosure will now be described.

The method of producing the ion conductive solid of the present disclosure can be allowed to be the following aspect, but is not limited thereto.

A method of producing an ion conductive solid including an oxide represented by a general formula: Li_{6+a-c-2d}X_{1-a-b-c-d}M1ₐM2_{b}M3_{c}M4_{d}B₃O₉, the method being able to include:
a primary baking step of heat-treating raw materials, mixed to obtain the oxide represented by the general formula, at a temperature that is less than the melting point of the oxide.

In the formula, X is at least one metal element selected from the group consisting of Lu, Ho, Er, and Tm,
M1 is at least one metal element selected from the group consisting of Mg, Mn, Zn, Ni, Ca, Sr, and Ba,
M2 is at least one metal element selected from the group consisting of La, Pr, Nd, Sm, Eu, Gd, Tb, Dy, Ho, Er, Tm, Lu, In, Fe, and Sc,
M3 is at least one metal element selected from the group consisting of Zr, Ce, Hf, Sn, and Ti,
M4 is at least one metal element selected from the group consisting of Nb and Ta, and
a is 0.000≤a≤0.800, b is 0.000≤b≤0.900, c is 0.000≤c≤0.800, d is 0.000≤d≤0.800, and a, b, c, and d are real numbers satisfying 0.000≤a+b+c+d<1.000, provided that a case in which X and M2 are the same metal elements is excluded.

The method of producing the ion conductive solid of the present disclosure can include the primary baking step of weighing and mixing the raw materials to obtain the oxide represented by the general formula above, heat-treating the raw materials at a temperature that is less than the melting point of the oxide, and thereby producing the ion conductive solid including the oxide. The ion conductive solid can be obtained by the primary baking step.

The production method may further include, as needed, a secondary baking step of heat-treating the ion conductive solid including the obtained oxide at a temperature that is less than the melting point of the oxide, and producing a sintered body of the ion conductive solid including the oxide.

The method of producing the ion conductive solid of the present disclosure, including the above-described primary baking step and the above-described secondary baking step, will be described in detail below. However, the present disclosure is not limited to the following production method.

### Primary Baking Step

In the primary baking step, raw materials, such as Li₂CO₃, H₃BO₃, Ho₂O₃, ZrO₂, CeO₂, or HfO₂, of the chemical reagent grade are weighed in stoichiometric amounts, and mixed to achieve a general formula: Li_{6+a-c-2d}X_{1-a-b-c-d} M1ₐM2_{b}M3_{c}M4_{d}B₃O₉ (wherein X is at least one metal element selected from the group consisting of Lu, Ho, Er, and Tm,
M1 is at least one metal element selected from the group consisting of Mg, Mn, Zn, Ni, Ca, Sr, and Ba,
M2 is at least one metal element selected from the group consisting of La, Pr, Nd, Sm, Eu, Gd, Tb, Dy, Ho, Er, Tm, Lu, In, Fe, and Sc,
M3 is at least one metal element selected from the group consisting of Zr, Ce, Hf, Sn, and Ti,
M4 is at least one metal element selected from the group consisting of Nb and Ta, and
a is 0.000≤a≤0.800, b is 0.000≤b≤0.900, c is 0.000≤c≤0.800, d is 0.000≤d≤0.800, and a, b, c, and d are real numbers satisfying 0.000≤a+b+c+d<1.000, provided that a case in which X and M2 are the same metal elements is excluded.)

An apparatus used in the mixture is not particularly limited. For example, a pulverizing-type mixer such as a planetary ball mill can be used as the apparatus. The material and capacity of a container used in the mixture, and the material and diameter of the ball are not particularly limited, and can be selected as appropriate depending on the kinds and amounts of the raw materials used. As an example, a 45 mL container made of zirconia, and a ball that has a diameter of 5 mm and is made of zirconia can be used. Moreover, the conditions of mixture treatment are not particularly limited but can be set at, for example, a rotation number of 50 rpm to 2000 rpm, and a time of 10 minutes to 60 minutes.

The powder mixture of each of the raw materials described above is obtained by the mixture treatment. Then, the obtained powder mixture is pressure-molded to make pellets. A known pressure molding method such as a cold uniaxial molding method or a cold isostatic pressure molding method can be used as a pressure molding method. The condition of the pressure molding in the primary baking step is not particularly limited but can be set at, for example, a pressure of 100 MPa to 200 MPa.

The obtained pellets are baked using a baking apparatus such as an atmosphere baking apparatus. A temperature at primary baking and solid-phase synthesis are performed is not particularly limited as long as the temperature is less than the melting point of the ion conductive solid represented by general formula: Li_{6+a-c-2d}X_{1-a-b-c-d}M1ₐM2_{b}M3_{c}M4_{d}B₃O₉. A temperature at which primary baking is performed can be set at, for example, less than 700° C., 680° C. or less, 670° C. or less, 660° C. or less, or 650° C. or less, and can be set at, for example, 500° C. or more. The numerical ranges can be optionally combined. The temperature in such a range as described above sufficiently enables the solid-phase synthesis. The time of the primary baking step is not particularly limited but can be set at, for example, around 700 minutes to 750 minutes.

The primary baking step described above enables production of the ion conductive solid including the oxide represented by the general formula above: Li_{6+a-c-2d}X_{1-a-b-c-d}M1ₐM2_{b}M3_{c}M4_{d}B₃O₉. The powder of the ion conductive solid including the oxide can also be obtained by pulverizing the ion conductive solid including the oxide using a mortar/pestle or a planetary mill.

### Secondary Baking Step

In the secondary baking step, the sintered body of the ion conductive solid including the oxide is obtained by optionally pressure-molding and baking at least one selected from the group consisting of the ion conductive solid including the oxide, obtained in the primary baking step, and the powder of the ion conductive solid including the oxide.

It is acceptable to simultaneously perform the pressure molding and the secondary baking using discharge plasma sintering (hereinafter also simply referred to as “SPS”.), hot press, or the like, or it is acceptable to produce pellets by cold uniaxial molding and to then perform the secondary baking in ambient atmosphere, oxidizing atmosphere, reducing atmosphere, or the like. The conditions described above enable an ion conductive solid having a high ionic conductivity to be obtained without causing melting due to heat treatment. The condition of the pressure molding in the secondary baking step is not particularly limited but can be set at, for example, a pressure of 10 MPa to 100 MPa.

The temperature at which the secondary baking is performed is less than the melting point of the ion conductive solid represented by general formula: Li_{6+a-c-2d}X_{1-a-b-c-d}M1ₐM2_{b}M3_{c}M4_{d}B₃O₉. The temperature at which the secondary baking is performed is preferably less than 700° C., more preferably 680° C. or less, still more preferably 670° C. or less, and particularly preferably 660° C. or less. The lower limit of the temperature is not particularly limited. It is preferable to reduce the lower limit as much as possible. For example, the lower limit is 500° C. or more. The numerical ranges can be optionally combined, and can be set in a range of, for example, 500° C. or more and less than 700° C. The range described above enables the ion conductive solid including the oxide of the present disclosure to be inhibited from being melted or decomposed in the secondary baking step, and enables the sintered body of the ion conductive solid including the oxide of the present disclosure, which has been sufficiently sintered, to be obtained.

The time for which the secondary baking step is performed can be changed as appropriate depending on the temperature or pressure at which the secondary baking is performed, and the like, is preferably 24 hours or less, and may be set at 14 hours or less. The time for which the secondary baking step is performed may be set at, for example, 5 minutes or more, 1 hour or more, and 6 hours or more.

A method of cooling the sintered body of the ion conductive solid including the oxide of the present disclosure, obtained in the secondary baking step, is not particularly limited, but may be subjected to natural radiational cooling (radiational cooling in a furnace), to rapid cooling, or to slower cooling than natural radiational cooling, or may be maintained at a certain temperature during cooling.

An all-solid-state battery of the present disclosure will now be described.

An all-solid-state battery commonly comprises: a cathode; an anode; an electrolyte that is placed between the cathode and the anode, and comprises an ion conductive solid; and, if necessary, a current collector.

The all-solid-state battery of the present disclosure is an all-solid-state battery comprises at least:
a cathode;
an anode; and
an electrolyte,
wherein at least one selected from the group consisting of the cathode, the anode, and the electrolyte comprises the ion conductive solid of the present disclosure.

The all-solid-state battery of the present disclosure may be a bulk-type battery, or may be a thin-film battery. The specific shape of the all-solid-state battery of the present disclosure is not particularly limited, but examples of the shape include coin, button, sheet, and layered shapes.

The all-solid-state battery of the present disclosure comprises the electrolyte. In the all-solid-state battery of the present disclosure, at least the electrolyte preferably comprises the ion conductive solid of the present disclosure.

The solid electrolyte in the all-solid-state battery of the present disclosure may comprise the ion conductive solid of the present disclosure, may comprise another ion conductive solid, or may comprise an ionic liquid or a gel polymer. The other ion conductive solid is not particularly limited but may comprise an ion conductive solid that is usually used in an all-solid-state battery, for example, LiI, Li₃PO₄, Li₇La₃Zr₂O₁₂, or the like. The content of the ion conductive solid of the present disclosure in the electrolyte in the all-solid-state battery of the present disclosure is not particularly limited, but is preferably 25% by mass or more, more preferably 50% by mass or more, still more preferably 75% by mass or more, and particularly preferably 100% by mass.

The all-solid-state battery of the present disclosure comprises the cathode. The cathode may comprise the cathode active material, or may comprise the cathode active material and the ion conductive solid of the present disclosure. As the cathode active material, a known cathode active material such as a sulfide comprising a transition metal element, or an oxide including lithium and a transition metal element can be used without particular limitation. Examples thereof include LiNiVO₄, LiCoPO₄, LiCoVO₄, LiMn_{1.6}Ni_{0.4}O₄, LiMn₂O₄, LiCoO₂, Fe₂(SO₄)₃, LiFePO₄, LiNi_{1/3}Mn_{1/3}Co_{1/3}O₂, LiNi_{1/2}Mn_{1/2}O₂, LiNiO₂, Li₁₊ₓ(Fe,Mn,Co)₁₋ₓO₂, LiNi_{0.8}Co_{0.15}Al_{0.05}O₂.

Further, the cathode may comprise a binder, an electroconductive agent, and/or the like. Examples of the binder include polyvinylidene fluoride, polytetrafluoroethylene, and polyvinyl alcohol. Examples of the electroconductive agent include natural graphite, artificial graphite, acetylene black, and ethylene black.

The all-solid-state battery of the present disclosure comprises the anode. The anode may comprise the anode active material, or may comprise the anode active material and the ion conductive solid of the present disclosure. As the anode active material, a known anode active material such as an inorganic compound such as lithium, a lithium alloy, or a tin compound, a carbonaceous material that can absorb and release a lithium ion, or a conductive polymer can be used without particular limitation. Examples thereof include Li₄Ti₅O₁₂.

Further, the anode may comprise a binder, an electroconductive agent, and/or the like. As the binder and the electroconductive agent, binders and electroconductive agents similar to those mentioned in the cathode can be used.

As used herein, the phrase “electrode comprises electrode active material” means that an electrode comprises an electrode active material as a constituent, an element, or a property. For example, a case in which an electrode active material is contained in an electrode, and a case in which an electrode active material is applied to a surface of an electrode also correspond to the above-described term “comprise”.

The cathode and the anode can be obtained by a known method such as mixture, molding, heat treatment, or the like of raw materials. It is considered that, as a result, the ion conductive solid enters gaps and the like between such electrode active materials, to facilitate security of a conduction path for lithium ions. It is considered that the formation of a high-resistant phase generated by reaction between the ion conductive solid and the electrode active material can be suppressed because the ion conductive solid of the present disclosure can be produced by heat treatment at low temperature as compared to conventional technologies.

The above-described cathode and the above-described anode may comprise the current collector. As the current collector, a known current collector such as aluminum, titanium, stainless steel, nickel, iron, baked carbon, a conductive polymer, or electrically conductive glass can be used. In addition, aluminum, copper, or the like, of which a surface is treated with carbon, nickel, titanium, silver, or the like for the purpose of improving adhesiveness, electrical conductivity, oxidation resistance, and the like, can be used as the current collector.

The all-solid-state battery of the present disclosure can be obtained by a known method in which, for example, the cathode, the solid electrolyte, and the anode are layered, molded, and heat-treated. It is considered that the formation of a high-resistant phase generated by reaction between the ion conductive solid and the electrode active material can be suppressed because the ion conductive solid of the present disclosure can be produced by heat treatment at low temperature as compared to conventional technologies. Thus, it is considered that the all-solid-state battery superior in output characteristics can be obtained.

A method of measuring the composition and each physical property according to the present disclosure will now be described.

### Methods of Identifying and Analyzing Contained Metals

The analysis of the composition of the ion conductive solid is performed by wavelength dispersion type fluorescent X-ray analysis (hereinafter also referred to as “XRF”) using a sample solidified by a pressure-molding method. However, when the analysis is difficult due to a particle size effect and/or the like, it is preferable to vitrify the ion conductive solid by a glass bead technique, and to analyze the composition thereof by XRF. When the peaks of yttrium and the peaks of the contained metals overlap with each other in XRF, the composition analysis is preferably performed by inductively coupled plasma atomic emission spectrochemical analysis (ICP-AES).

In the case of XRF, ZSX Primus II manufactured by Rigaku Corporation is used as an analysis apparatus. The conditions of the analysis are set at use of Rh as the anode of an X-ray tube, vacuum atmosphere, an analysis diameter of 10 mm, an analysis range of 17 deg to 81 deg, a step of 0.01 deg, and a scanning speed of 5 sec/step. Moreover, the detection is performed by a proportional counter in the case of measuring a light element, while the detection is performed by a scintillation counter in the case of measuring a heavy element.

An element is identified based on the peak position of a spectrum obtained in XRF, and molar concentration ratios are calculated based on a counting rate (unit: cps) which is the number of X-ray photons per unit time, to determine a, b, c, and d.

### EXAMPLES

Examples in which the ion conductive solid of the present disclosure was specifically produced and evaluated are described below as Examples. The present disclosure is not limited to the following Examples.

### Example 1

### Primary Baking Step

Using Li₂CO₃ (manufactured by NACALAI TESQUE, INC., purity of 99.0% by mass), H₃BO₃ (manufactured by KANTO CHEMICAL CO., INC., purity of 99.5%), Lu₂O₃ (manufactured by Kojundo Chemical Laboratory Co., Ltd., purity of 99.9% by mass), and Nb₂O₅ (manufactured by MITSUI MINING & SMELTING CO., LTD., purity of 99.9%) as raw materials, each raw material was weighed in stoichiometric amounts so that d was a value set forth in Table 1, and was mixed in a planetary mill P-7 manufactured by Fritsch GmbH at a disk rotation number of 300 rpm for 30 minutes. A ball with a diameter of 5 mm, made of zirconia, and a 45 mL container were used in the planetary mill.

After the mixing, the mixed powder was cold uniaxially molded at 147 MPa using a 100 kN electrically operated press apparatus P3052-10 manufactured by NPa SYSTEM Co., Ltd., and baked in ambient atmosphere. The heating temperature was set at 650° C., and the retention time was set at 720 minutes.

The obtained ion conductive solid including the oxide was ground for 180 minutes at a disk rotation number of 230 rpm in the planetary mill P-7 manufactured by Fritsch GmbH, to produce the powder of the ion conductive solid including the oxide.

### Secondary Baking Step

The powder of the ion conductive solid including the oxide, obtained as described above, was molded and secondarily baked to produce a sintered body of the ion conductive solid including the oxide of Example 1. For the molding, the powder was cold uniaxially molded at 147 MPa using a 100 kN electrically operated press apparatus P3052-10 manufactured by NPa SYSTEM Co., Ltd. The secondary baking was performed in ambient atmosphere, the heating temperature was set at 650° C., and the retention time was set at 720 minutes.

### Example 2

The sintered body of the ion conductive solid including the oxide of Example 2 was produced in the same step as that in Example 1 except that using Li₂CO₃ (manufactured by NACALAI TESQUE, INC., purity of 99.0% by mass), H₃BO₃ (manufactured by KANTO CHEMICAL CO., INC., purity of 99.5%), Lu₂O₃ (manufactured by Kojundo Chemical Laboratory Co., Ltd., purity of 99.9% by mass), and CeO₂ (manufactured by Shin-Etsu Chemical Co., Ltd., purity of 99.9%) as raw materials, each raw material was weighed in stoichiometric amounts so that c was a value set forth in Table 1.

### Example 3

The sintered body of the ion conductive solid including the oxide of Example 3 was produced in the same step as that in Example 1 except that using Li₂CO₃ (manufactured by NACALAI TESQUE, INC., purity of 99.0% by mass), H₃BO₃ (manufactured by KANTO CHEMICAL CO., INC., purity of 99.5%), Lu₂O₃ (manufactured by Kojundo Chemical Laboratory Co., Ltd., purity of 99.9% by mass), ZrO₂ (manufactured by NIPPON DENKO CO., LTD., purity of 99.9%), CeO₂ (manufactured by Shin-Etsu Chemical Co., Ltd., purity of 99.9%) and Nb₂O₅ (manufactured by MITSUI MINING & SMELTING CO., LTD., purity of 99.9%) as raw materials, each raw material was weighed in stoichiometric amounts so that c and d were values set forth in Table 1.

### Example 4

The sintered body of the ion conductive solid including the oxide of Example 4 was produced in the same step as that in Example 1 except that each raw material used in Examples as described above was weighed in stoichiometric amounts so that values set forth in Table 1 were achieved.

### Example 5

The sintered body of the ion conductive solid including the oxide of Example 5 was produced in the same step as that in Example 1 except that using Li₂CO₃ (manufactured by NACALAI TESQUE, INC., purity of 99.0% by mass), H₃BO₃ (manufactured by KANTO CHEMICAL CO., INC., purity of 99.5%), Lu₂O₃ (manufactured by Kojundo Chemical Laboratory Co., Ltd., purity of 99.9% by mass), and HfO₂ (manufactured by New Metals and Chemicals Corporation, Ltd., purity of 99.9%) as raw materials, each raw material was weighed in stoichiometric amounts so that c was a value set forth in Table 1.

### Example 6

The sintered body of the ion conductive solid including the oxide of Example 6 was produced in the same step as that in Example 1 except that each raw material used in Examples as described above was weighed in stoichiometric amounts so that c was a value set forth in Table 1.

### Example 7

The sintered body of the ion conductive solid including the oxide of Example 7 was produced in the same step as that in Example 1 except that Example 1 except that each raw material used in Examples as described above was weighed in stoichiometric amounts so that c and d were values set forth in Table 1.

### Example 8

The sintered body of the ion conductive solid including the oxide of Example 8 was produced in the same step as that in Example 1 except that using Li₂CO₃ (manufactured by NACALAI TESQUE, INC., purity of 99.0% by mass), H₃BO₃ (manufactured by KANTO CHEMICAL CO., INC., purity of 99.5%), Lu₂O₃ (manufactured by Kojundo Chemical Laboratory Co., Ltd., purity of 99.9% by mass), In₂O₃ (manufactured by Shinko Chemical Co., Ltd., purity of 99% by mass), SnO₂ (manufactured by Mitsuwa Chemicals Co., Ltd., purity of 99.9%) and CeO₂ (manufactured by Shin-Etsu Chemical Co., Ltd., purity of 99.9%) as raw materials, each raw material was weighed in stoichiometric amounts so that b and c were values set forth in Table 1.

### Example 9

The sintered body of the ion conductive solid including the oxide of Example 9 was produced in the same step as that in Example 1 except that each raw material used in Examples as described above was weighed in stoichiometric amounts so that b and c were values set forth in Table 1.

### Example 10

The sintered body of the ion conductive solid including the oxide of Example 10 was produced in the same step as that in Example 1 except that using Li₂CO₃ (manufactured by NACALAI TESQUE, INC., purity of 99.0% by mass), H₃BO₃ (manufactured by KANTO CHEMICAL CO., INC., purity of 99.5%), Lu₂O₃ (manufactured by Kojundo Chemical Laboratory Co., Ltd., purity of 99.9% by mass), Fe₂O₃ (manufactured by Wako Pure Chemical Industries, Ltd., purity of 95.0% by mass), and TiO₂ (manufactured by TOHO TITANIUM CO., LTD., purity of 99%) as raw materials, each raw material was weighed in stoichiometric amounts so that b and c were values set forth in Table 1.

### Example 11

The sintered body of the ion conductive solid including the oxide of Example 11 was produced in the same step as that in Example 1 except that each raw material used in Examples as described above was weighed in stoichiometric amounts so that b and c were values set forth in Table 1.

### Example 12

The sintered body of the ion conductive solid including the oxide of Example 12 was produced in the same step as that in Example 1 except that using Li₂CO₃ (manufactured by NACALAI TESQUE, INC., purity of 99.0% by mass), B₂O₃(manufactured by Wako Pure Chemical Industries, Ltd., purity of 99.9%), Ho₂O₃ (manufactured by Kojundo Chemical Laboratory Co., Ltd., purity of 99.9% by mass), and Lu₂O₃ (manufactured by Kojundo Chemical Laboratory Co., Ltd., purity of 99.9% by mass) as raw materials, each raw material was weighed in stoichiometric amounts so that b was a value set forth in Table 1.

### Example 13

The sintered body of the ion conductive solid including the oxide of Example 13 was produced in the same step as that in Example 1 except that using Li₂CO₃ (manufactured by NACALAI TESQUE, INC., purity of 99.0% by mass), H₃BO₃ (manufactured by KANTO CHEMICAL CO., INC., purity of 99.5%), Lu₂O₃ (manufactured by Kojundo Chemical Laboratory Co., Ltd., purity of 99.9% by mass), MgO (manufactured by Ube Material Industries, Ltd., purity of 99.0% by mass), and CeO₂ (manufactured by Shin-Etsu Chemical Co., Ltd., purity of 99.9%) as raw materials, each raw material was weighed in stoichiometric amounts so that a and c were values set forth in Table 1.

### Example 14

The sintered body of the ion conductive solid including the oxide of Example 14 was produced in the same step as that in Example 1 except that using Li₂CO₃ (manufactured by NACALAI TESQUE, INC., purity of 99.0% by mass), H₃BO₃ (manufactured by KANTO CHEMICAL CO., INC., purity of 99.5%), Lu₂O₃ (manufactured by Kojundo Chemical Laboratory Co., Ltd., purity of 99.9% by mass), La₂O₃(manufactured by Wako Pure Chemical Industries, Ltd., purity of 99.9% by mass), MgO (manufactured by Ube Material Industries, Ltd., purity of 99.0% by mass), and CaO (manufactured by KANTO CHEMICAL CO., INC., purity of 97.0% by mass) as raw materials, each raw material was weighed in stoichiometric amounts so that a and b were values set forth in Table 1.

### Example 15

The sintered body of the ion conductive solid including the oxide of Example 15 was produced in the same step as that in Example 1 except that using Li₂CO₃ (manufactured by NACALAI TESQUE, INC., purity of 99.0% by mass), H₃BO₃ (manufactured by KANTO CHEMICAL CO., INC., purity of 99.5%), Lu₂O₃ (manufactured by Kojundo Chemical Laboratory Co., Ltd., purity of 99.9% by mass), La₂O₃ (manufactured by Wako Pure Chemical Industries, Ltd., purity of 99.9% by mass), and MnO (manufactured by KANTO CHEMICAL CO., INC., purity of 80.0% by mass) as raw materials, each raw material was weighed in stoichiometric amounts so that a and b were values set forth in Table 1.

### Example 16

The sintered body of the ion conductive solid including the oxide of Example 16 was produced in the same step as that in Example 1 except that using Li₂CO₃ (manufactured by NACALAI TESQUE, INC., purity of 99.0% by mass), H₃BO₃ (manufactured by KANTO CHEMICAL CO., INC., purity of 99.5%), Lu₂O₃ (manufactured by Kojundo Chemical Laboratory Co., Ltd., purity of 99.9% by mass), Tb₂O₃(manufactured by Shin-Etsu Chemical Co., Ltd., purity of 99.9% by mass), and MnO (manufactured by KANTO CHEMICAL CO., INC., purity of 80.0% by mass) as raw materials, each raw material was weighed in stoichiometric amounts so that a and b were values set forth in Table 1.

### Example 17

The sintered body of the ion conductive solid including the oxide of Example 17 was produced in the same step as that in Example 1 except that using Li₂CO₃ (manufactured by NACALAI TESQUE, INC., purity of 99.0% by mass), H₃BO₃ (manufactured by KANTO CHEMICAL CO., INC., purity of 99.5%), Lu₂O₃ (manufactured by Kojundo Chemical Laboratory Co., Ltd., purity of 99.9% by mass), Tm₂O₃ (manufactured by Kojundo Chemical Laboratory Co., Ltd., purity of 99.9% by mass), and MnO (manufactured by KANTO CHEMICAL CO., INC., purity of 80.0% by mass) as raw materials, each raw material was weighed in stoichiometric amounts so that a and b were values set forth in Table 1.

### Example 18

The sintered body of the ion conductive solid including the oxide of Example 18 was produced in the same step as that in Example 1 except that each raw material used in Examples as described above was weighed in stoichiometric amounts so that c and d were values set forth in Table 1.

### Example 19

The sintered body of the ion conductive solid including the oxide of Example 19 was produced in the same step as that in Example 1 except that using Li₂CO₃ (manufactured by NACALAI TESQUE, INC., purity of 99.0% by mass), H₃BO₃ (manufactured by KANTO CHEMICAL CO., INC., purity of 99.5%), Lu₂O₃ (manufactured by Kojundo Chemical Laboratory Co., Ltd., purity of 99.9% by mass), In₂O₃ (manufactured by Shinko Chemical Co., Ltd., purity of 99% by mass), Nb₂O₅(manufactured by MITSUI MINING & SMELTING CO., LTD., purity of 99.9%) and Ta₂O₅ (manufactured by KANTO CHEMICAL CO., INC., purity of 99% by mass) as raw materials, each raw material was weighed in stoichiometric amounts so that b and d were values set forth in Table 1.

### Example 20

The sintered body of the ion conductive solid including the oxide of Example 20 was produced in the same step as that in Example 1 except that using Li₂CO₃ (manufactured by NACALAI TESQUE, INC., purity of 99.0% by mass), H₃BO₃ (manufactured by KANTO CHEMICAL CO., INC., purity of 99.5%), Lu₂O₃ (manufactured by Kojundo Chemical Laboratory Co., Ltd., purity of 99.9% by mass), and Pr₂O₃ (manufactured by Shin-Etsu Chemical Co., Ltd., purity of 99.9% by mass) as raw materials, each raw material was weighed in stoichiometric amounts so that b was a value set forth in Table 1.

### Example 21

The sintered body of the ion conductive solid including the oxide of Example 21 was produced in the same step as that in Example 1 except that each raw material used in Examples as described above was weighed in stoichiometric amounts so that b and d were values set forth in Table 1.

### Example 22

The sintered body of the ion conductive solid including the oxide of Example 22 was produced in the same step as that in Example 1 except that using Li₂CO₃ (manufactured by NACALAI TESQUE, INC., purity of 99.0% by mass), H₃BO₃ (manufactured by KANTO CHEMICAL CO., INC., purity of 99.5%), Lu₂O₃ (manufactured by Kojundo Chemical Laboratory Co., Ltd., purity of 99.9% by mass), Sm₂O₃ (manufactured by Wako Pure Chemical Industries, Ltd., purity of 99.9% by mass), HfO₂ (manufactured by New Metals and Chemicals Corporation, Ltd., purity of 99.9%) and Ta₂O₅ (manufactured by KANTO CHEMICAL CO., INC., purity of 99% by mass) as raw materials, each raw material was weighed in stoichiometric amounts so that b, c, and d were values set forth in Table 1.

### Example 23

The sintered body of the ion conductive solid including the oxide of Example 23 was produced in the same step as that in Example 1 except that using Li₂CO₃ (manufactured by NACALAI TESQUE, INC., purity of 99.0% by mass), H₃BO₃ (manufactured by KANTO CHEMICAL CO., INC., purity of 99.5%), Lu₂O₃ (manufactured by Kojundo Chemical Laboratory Co., Ltd., purity of 99.9% by mass), Nd₂O₃(manufactured by Shin-Etsu Chemical Co., Ltd., purity of 99.9% by mass), Sm₂O₃ (manufactured by Wako Pure Chemical Industries, Ltd., purity of 99.9% by mass), and ZnO (manufactured by Wako Pure Chemical Industries, Ltd., purity of 99% by mass) as raw materials, each raw material was weighed in stoichiometric amounts so that a and b were values set forth in Table 1.

### Example 24

The sintered body of the ion conductive solid including the oxide of Example 24 was produced in the same step as that in Example 1 except that each raw material used in Examples as described above was weighed in stoichiometric amounts so that b and c were values set forth in Table 1.

### Example 25

The sintered body of the ion conductive solid including the oxide of Example 25 was produced in the same step as that in Example 1 except that using Li₂CO₃ (manufactured by NACALAI TESQUE, INC., purity of 99.0% by mass), H₃BO₃ (manufactured by KANTO CHEMICAL CO., INC., purity of 99.5%), Lu₂O₃ (manufactured by Kojundo Chemical Laboratory Co., Ltd., purity of 99.9% by mass), and Eu₂O₃ (manufactured by Shin-Etsu Chemical Co., Ltd., purity of 95% by mass) as raw materials, each raw material was weighed in stoichiometric amounts so that b was a value set forth in Table 1.

### Example 26

The sintered body of the ion conductive solid including the oxide of Example 26 was produced in the same step as that in Example 1 except that using Li₂CO₃ (manufactured by NACALAI TESQUE, INC., purity of 99.0% by mass), H₃BO₃ (manufactured by KANTO CHEMICAL CO., INC., purity of 99.5%), Lu₂O₃ (manufactured by Kojundo Chemical Laboratory Co., Ltd., purity of 99.9% by mass), Eu₂O₃ (manufactured by Shin-Etsu Chemical Co., Ltd., purity of 95% by mass), and NiO (manufactured by Wako Pure Chemical Industries, Ltd., purity of 99.0% by mass) as raw materials, each raw material was weighed in stoichiometric amounts so that a and b were values set forth in Table 1.

### Example 27

The sintered body of the ion conductive solid including the oxide of Example 27 was produced in the same step as that in Example 1 except that each raw material used in Examples as described above was weighed in stoichiometric amounts so that b and c were values set forth in Table 1.

### Example 28

The sintered body of the ion conductive solid including the oxide of Example 28 was produced in the same step as that in Example 1 except that using Li₂CO₃ (manufactured by NACALAI TESQUE, INC., purity of 99.0% by mass), H₃BO₃ (manufactured by KANTO CHEMICAL CO., INC., purity of 99.5%), Lu₂O₃ (manufactured by Kojundo Chemical Laboratory Co., Ltd., purity of 99.9% by mass), Gd₂O₃(manufactured by Shin-Etsu Chemical Co., Ltd., purity of 99.9% by mass), Dy₂O₃ (manufactured by Shin-Etsu Chemical Co., Ltd., purity of 95% by mass), and CaO (manufactured by KANTO CHEMICAL CO., INC., purity of 99.0% by mass) as raw materials, each raw material was weighed in stoichiometric amounts so that a and b were values set forth in Table 1.

### Example 29

The sintered body of the ion conductive solid including the oxide of Example 29 was produced in the same step as that in Example 1 except that each raw material used in Examples as described above was weighed in stoichiometric amounts so that b and c were values set forth in Table 1.

### Example 30

The sintered body of the ion conductive solid including the oxide of Example 30 was produced in the same step as that in Example 1 except that each raw material used in Examples as described above was weighed in stoichiometric amounts so that b and c were values set forth in Table 1.

### Example 31

The sintered body of the ion conductive solid including the oxide of Example 31 was produced in the same step as that in Example 1 except that each raw material used in Examples as described above was weighed in stoichiometric amounts so that b was a value set forth in Table 1.

### Example 32

The sintered body of the ion conductive solid including the oxide of Example 32 was produced in the same step as that in Example 1 except that using Li₂CO₃ (manufactured by NACALAI TESQUE, INC., purity of 99.0% by mass), H₃BO₃ (manufactured by KANTO CHEMICAL CO., INC., purity of 99.5%), Lu₂O₃ (manufactured by Kojundo Chemical Laboratory Co., Ltd., purity of 99.9% by mass), Tb₂O₃(manufactured by Shin-Etsu Chemical Co., Ltd., purity of 99.9% by mass), NiO (manufactured by Wako Pure Chemical Industries, Ltd., purity of 99.0% by mass), and BaO (manufactured by Wako Pure Chemical Industries, Ltd., purity of 90.0% by mass) as raw materials, each raw material was weighed in stoichiometric amounts so that a and b were values set forth in Table 1.

### Example 33

The sintered body of the ion conductive solid including the oxide of Example 33 was produced in the same step as that in Example 1 except that using Li₂CO₃ (manufactured by NACALAI TESQUE, INC., purity of 99.0% by mass), H₃BO₃ (manufactured by KANTO CHEMICAL CO., INC., purity of 99.5%), Lu₂O₃ (manufactured by Kojundo Chemical Laboratory Co., Ltd., purity of 99.9% by mass), Tb₂O₃(manufactured by Shin-Etsu Chemical Co., Ltd., purity of 99.9% by mass), Ho₂O₃ (manufactured by Kojundo Chemical Laboratory Co., Ltd., purity of 99.9% by mass), and BaO (manufactured by Wako Pure Chemical Industries, Ltd., purity of 90.0% by mass) as raw materials, each raw material was weighed in stoichiometric amounts so that a and b were values set forth in Table 1.

### Example 34

The sintered body of the ion conductive solid including the oxide of Example 34 was produced in the same step as that in Example 1 except that each raw material used in Examples as described above was weighed in stoichiometric amounts so that b, c, and d were values set forth in Table 1.

### Example 35

The sintered body of the ion conductive solid including the oxide of Example 35 was produced in the same step as that in Example 1 except that using Li₂CO₃ (manufactured by NACALAI TESQUE, INC., purity of 99.0% by mass), H₃BO₃ (manufactured by KANTO CHEMICAL CO., INC., purity of 99.5%), Lu₂O₃ (manufactured by Kojundo Chemical Laboratory Co., Ltd., purity of 99.9% by mass), Er₂O₃ (manufactured by Shin-Etsu Chemical Co., Ltd., purity of 95% by mass), Tm₂O₃ (manufactured by Kojundo Chemical Laboratory Co., Ltd., purity of 99.9% by mass), and SrO (manufactured by Kojundo Chemical Laboratory Co., Ltd., purity of 98% by mass) as raw materials, each raw material was weighed in stoichiometric amounts so that a and b were values set forth in Table 1.

### Example 36

The sintered body of the ion conductive solid including the oxide of Example 36 was produced in the same step as that in Example 1 except that each raw material used in Examples as described above was weighed in stoichiometric amounts so that b and c were values set forth in Table 1.

### Example 37

The sintered body of the ion conductive solid including the oxide of Example 37 was produced in the same step as that in Example 1 except that each raw material used in Examples as described above was weighed in stoichiometric amounts so that a, b, and c were values set forth in Table 1.

### Example 38

The sintered body of the ion conductive solid including the oxide of Example 38 was produced in the same step as that in Example 1 except that each raw material used in Examples as described above was weighed in stoichiometric amounts so that b and d were values set forth in Table 1.

### Example 39

The sintered body of the ion conductive solid including the oxide of Example 39 was produced in the same step as that in Example 1 except that each raw material used in Examples as described above was weighed in stoichiometric amounts so that b, c, and d were values set forth in Table 1.

### Example 40

The sintered body of the ion conductive solid including the oxide of Example 40 was produced in the same step as that in Example 1 except that each raw material used in Examples as described above was weighed in stoichiometric amounts so that a, b, and c were values set forth in Table 1.

### Example 41

The sintered body of the ion conductive solid including the oxide of Example 41 was produced in the same step as that in Example 1 except that each raw material used in Examples as described above was weighed in stoichiometric amounts so that b and d were values set forth in Table 1.

### Example 42

The sintered body of the ion conductive solid including the oxide of Example 42 was produced in the same step as that in Example 1 except that each raw material used in Examples as described above was weighed in stoichiometric amounts so that b and d were values set forth in Table 1.

### Example 43

The sintered body of the ion conductive solid including the oxide of Example 26 was produced in the same step as that in Example 1 except that using Li₂CO₃ (manufactured by NACALAI TESQUE, INC., purity of 99.0% by mass), H₃BO₃ (manufactured by KANTO CHEMICAL CO., INC., purity of 99.5%), Lu₂O₃ (manufactured by Kojundo Chemical Laboratory Co., Ltd., purity of 99.9% by mass), and Sc₂O₃ (manufactured by Kojundo Chemical Laboratory Co., Ltd., purity of 99.9% by mass) as raw materials, each raw material was weighed in stoichiometric amounts so that b was a value set forth in Table 1.

### Example 44

The sintered body of the ion conductive solid including the oxide of Example 44 was produced in the same step as that in Example 1 except that each raw material used in Examples as described above was weighed in stoichiometric amounts so that a and b were values set forth in Table 1, and a disk rotation number in pulverization was set at 300 rpm.

### Example 45

The sintered body of the ion conductive solid including the oxide of Example 45 was produced in the same step as that in Example 1 except that each raw material used in Examples as described above was weighed in stoichiometric amounts so that a and b were values set forth in Table 1, and a disk rotation number in pulverization was set at 300 rpm.

### Example 46

The sintered body of the ion conductive solid including the oxide of Example 46 was produced in the same step as that in Example 1 except that each raw material used in Examples as described above was weighed in stoichiometric amounts so that a and b were values set forth in Table 1, and a disk rotation number in pulverization was set at 300 rpm.

### Example 47

The sintered body of the ion conductive solid including the oxide of Example 47 was produced in the same step as that in Example 1 except that each raw material used in Examples as described above was weighed in stoichiometric amounts so that a and b were values set forth in Table 1, and a disk rotation number in pulverization was set at 150 rpm and a pulverization time was set at 60 minutes.

### Comparative Example 1

The sintered body of the ion conductive solid including the oxide of Comparative Example 1 was produced in the same step as that in Example 1 except that Lu₂O₃ as a raw material in Example 1 was changed to Y₂O₃ and each raw material was weighed in stoichiometric amounts so that d was a value set forth in Table 1.

### Comparative Example 2

The sintered body of the ion conductive solid including the oxide of Comparative Example 2 was produced in the same step as that in Example 2 except that Lu₂O₃ as a raw material in Example 2 was changed to Y₂O₃ and each raw material was weighed in stoichiometric amounts so that c was a value set forth in Table 1.

### Comparative Example 3

The sintered body of the ion conductive solid including the oxide of Comparative Example 3 was produced in the same step as that in Example 3 except that Lu₂O₃ as a raw material in Example 3 was changed to Y₂O₃ and each raw material was weighed in stoichiometric amounts so that c and d were values set forth in Table 1.

### Example 101

### Primary Baking Step

Using Li₂CO₃ (manufactured by NACALAI TESQUE, INC., purity of 99.0% by mass), H₃BO₃ (manufactured by KANTO CHEMICAL CO., INC., purity of 99.5%), Ho₂O₃ (manufactured by Kojundo Chemical Laboratory Co., Ltd., purity of 99.9% by mass), and Nb₂O₅(manufactured by MITSUI MINING & SMELTING CO., LTD., purity of 99.9%) as raw materials, each raw material was weighed in stoichiometric amounts so that d was a value set forth in Table 2, and was mixed in a planetary mill P-7 manufactured by Fritsch GmbH at a disk rotation number of 300 rpm for 30 minutes. A ball with a diameter of 5 mm, made of zirconia, and a 45 mL container were used in the planetary mill.

After the mixing, the mixed powder was cold uniaxially molded at 147 MPa using a 100 kN electrically operated press apparatus P3052-10 manufactured by NPa SYSTEM Co., Ltd., and baked in ambient atmosphere. The heating temperature was set at 650° C., and the retention time was set at 720 minutes.

The obtained ion conductive solid including the oxide was ground for 180 minutes at a disk rotation number of 230 rpm in the planetary mill P-7 manufactured by Fritsch GmbH, to produce the powder of the ion conductive solid including the oxide.

### Secondary Baking Step

The powder of the ion conductive solid including the oxide, obtained as described above, was molded and secondarily baked to produce a sintered body of the ion conductive solid including the oxide of Example 101. For the molding, the powder was cold uniaxially molded at 147 MPa using a 100 kN electrically operated press apparatus P3052-10 manufactured by NPa SYSTEM Co., Ltd. The secondary baking was performed in ambient atmosphere, the heating temperature was set at 650° C., and the retention time was set at 720 minutes.

### Example 102

The sintered body of the ion conductive solid including the oxide of Example 102 was produced in the same step as that in Example 101 except that using Li₂CO₃ (manufactured by NACALAI TESQUE, INC., purity of 99.0% by mass), H₃BO₃ (manufactured by KANTO CHEMICAL CO., INC., purity of 99.5%), Ho₂O₃ (manufactured by Kojundo Chemical Laboratory Co., Ltd., purity of 99.9% by mass), and CeO₂ (manufactured by Shin-Etsu Chemical Co., Ltd., purity of 99.9%) as raw materials, each raw material was weighed in stoichiometric amounts so that c was a value set forth in Table 2.

### Example 103

The sintered body of the ion conductive solid including the oxide of Example 103 was produced in the same step as that in Example 101 except that using Li₂CO₃ (manufactured by NACALAI TESQUE, INC., purity of 99.0% by mass), H₃BO₃ (manufactured by KANTO CHEMICAL CO., INC., purity of 99.5%), Ho₂O₃ (manufactured by Kojundo Chemical Laboratory Co., Ltd., purity of 99.9% by mass), ZrO₂ (manufactured by NIPPON DENKO CO., LTD., purity of 99.9%), CeO₂ (manufactured by Shin-Etsu Chemical Co., Ltd., purity of 99.9%) and Nb₂O₅ (manufactured by MITSUI MINING & SMELTING CO., LTD., purity of 99.9%) as raw materials, each raw material was weighed in stoichiometric amounts so that c and d were values set forth in Table 2.

### Example 104

The sintered body of the ion conductive solid including the oxide of Example 104 was produced in the same step as that in Example 101 except that each raw material used in Examples as described above was weighed in stoichiometric amounts so that values set forth in Table 2 were achieved.

### Example 105

The sintered body of the ion conductive solid including the oxide of Example 105 was produced in the same step as that in Example 101 except that using Li₂CO₃ (manufactured by NACALAI TESQUE, INC., purity of 99.0% by mass), H₃BO₃ (manufactured by KANTO CHEMICAL CO., INC., purity of 99.5%), Ho₂O₃ (manufactured by Kojundo Chemical Laboratory Co., Ltd., purity of 99.9% by mass), and HfO₂ (manufactured by New Metals and Chemicals Corporation, Ltd., purity of 99.9%) as raw materials, each raw material was weighed in stoichiometric amounts so that c was a value set forth in Table 2.

### Example 106

The sintered body of the ion conductive solid including the oxide of Example 106 was produced in the same step as that in Example 101 except that each raw material used in Examples as described above was weighed in stoichiometric amounts so that c was a value set forth in Table 2.

### Example 107

The sintered body of the ion conductive solid including the oxide of Example 107 was produced in the same step as that in Example 101 except that each raw material used in Examples as described above was weighed in stoichiometric amounts so that c and d were values set forth in Table 2.

### Example 108

The sintered body of the ion conductive solid including the oxide of Example 108 was produced in the same step as that in Example 101 except that using Li₂CO₃ (manufactured by NACALAI TESQUE, INC., purity of 99.0% by mass), H₃BO₃ (manufactured by KANTO CHEMICAL CO., INC., purity of 99.5%), Ho₂O₃ (manufactured by Kojundo Chemical Laboratory Co., Ltd., purity of 99.9% by mass), In₂O₃ (manufactured by Shinko Chemical Co., Ltd., purity of 99% by mass), and SnO₂ (manufactured by Mitsuwa Chemicals Co., Ltd., purity of 99.9%) as raw materials, each raw material was weighed in stoichiometric amounts so that b and c were values set forth in Table 2.

### Example 109

The sintered body of the ion conductive solid including the oxide of Example 109 was produced in the same step as that in Example 101 except that each raw material used in Examples as described above was weighed in stoichiometric amounts so that b and c were values set forth in Table 2.

### Example 110

The sintered body of the ion conductive solid including the oxide of Example 110 was produced in the same step as that in Example 101 except that using Li₂CO₃ (manufactured by NACALAI TESQUE, INC., purity of 99.0% by mass), H₃BO₃ (manufactured by KANTO CHEMICAL CO., INC., purity of 99.5%), Ho₂O₃ (manufactured by Kojundo Chemical Laboratory Co., Ltd., purity of 99.9% by mass), Fe₂O₃ (manufactured by Wako Pure Chemical Industries, Ltd., purity of 95.0% by mass), and TiO₂ (manufactured by TOHO TITANIUM CO., LTD., purity of 99%) as raw materials, each raw material was weighed in stoichiometric amounts so that b and c were values set forth in Table 2.

### Example 111

The sintered body of the ion conductive solid including the oxide of Example 111 was produced in the same step as that in Example 101 except that each raw material used in Examples as described above was weighed in stoichiometric amounts so that b and c were values set forth in Table 2.

### Example 112

The sintered body of the ion conductive solid including the oxide of Example 112 was produced in the same step as that in Example 101 except that using Li₂CO₃ (manufactured by NACALAI TESQUE, INC., purity of 99.0% by mass), H₃BO₃ (manufactured by KANTO CHEMICAL CO., INC., purity of 99.5%), Ho₂O₃ (manufactured by Kojundo Chemical Laboratory Co., Ltd., purity of 99.9% by mass), MgO (manufactured by Ube Material Industries, Ltd., purity of 99.0% by mass), and CeO₂ (manufactured by Shin-Etsu Chemical Co., Ltd., purity of 99.9%) as raw materials, each raw material was weighed in stoichiometric amounts so that a and c were values set forth in Table 2.

### Example 113

The sintered body of the ion conductive solid including the oxide of Example 113 was produced in the same step as that in Example 101 except that using Li₂CO₃ (manufactured by NACALAI TESQUE, INC., purity of 99.0% by mass), H₃BO₃ (manufactured by KANTO CHEMICAL CO., INC., purity of 99.5%), Ho₂O₃ (manufactured by Kojundo Chemical Laboratory Co., Ltd., purity of 99.9% by mass), La₂O₃(manufactured by Wako Pure Chemical Industries, Ltd., purity of 99.9% by mass), MgO (manufactured by Ube Material Industries, Ltd., purity of 99.0% by mass), and CaO (manufactured by KANTO CHEMICAL CO., INC., purity of 97.0% by mass) as raw materials, each raw material was weighed in stoichiometric amounts so that a and b were values set forth in Table 2.

### Example 114

The sintered body of the ion conductive solid including the oxide of Example 114 was produced in the same step as that in Example 101 except that using Li₂CO₃ (manufactured by NACALAI TESQUE, INC., purity of 99.0% by mass), H₃BO₃ (manufactured by KANTO CHEMICAL CO., INC., purity of 99.5%), Ho₂O₃ (manufactured by Kojundo Chemical Laboratory Co., Ltd., purity of 99.9% by mass), Lu₂O₃ (manufactured by Kojundo Chemical Laboratory Co., Ltd., purity of 99.9% by mass), and MnO (manufactured by KANTO CHEMICAL CO., INC., purity of 80.0% by mass) as raw materials, each raw material was weighed in stoichiometric amounts so that a and b were values set forth in Table 2.

### Example 115

The sintered body of the ion conductive solid including the oxide of Example 115 was produced in the same step as that in Example 101 except that using Li₂CO₃ (manufactured by NACALAI TESQUE, INC., purity of 99.0% by mass), H₃BO₃ (manufactured by KANTO CHEMICAL CO., INC., purity of 99.5%), Ho₂O₃ (manufactured by Kojundo Chemical Laboratory Co., Ltd., purity of 99.9% by mass), Tb₂O₃(manufactured by Shin-Etsu Chemical Co., Ltd., purity of 99.9% by mass), and MnO (manufactured by KANTO CHEMICAL CO., INC., purity of 80.0% by mass) as raw materials, each raw material was weighed in stoichiometric amounts so that a and b were values set forth in Table 2.

### Example 116

The sintered body of the ion conductive solid including the oxide of Example 116 was produced in the same step as that in Example 101 except that using Li₂CO₃ (manufactured by NACALAI TESQUE, INC., purity of 99.0% by mass), H₃BO₃ (manufactured by KANTO CHEMICAL CO., INC., purity of 99.5%), Ho₂O₃ (manufactured by Kojundo Chemical Laboratory Co., Ltd., purity of 99.9% by mass), Tm₂O₃ (manufactured by Kojundo Chemical Laboratory Co., Ltd., purity of 99.9% by mass), and BaO (manufactured by Wako Pure Chemical Industries, Ltd., purity of 90.0% by mass) as raw materials, each raw material was weighed in stoichiometric amounts so that a and b were values set forth in Table 2.

### Example 117

The sintered body of the ion conductive solid including the oxide of Example 117 was produced in the same step as that in Example 101 except that using Li₂CO₃ (manufactured by NACALAI TESQUE, INC., purity of 99.0% by mass), H₃BO₃ (manufactured by KANTO CHEMICAL CO., INC., purity of 99.5%), Ho₂O₃ (manufactured by Kojundo Chemical Laboratory Co., Ltd., purity of 99.9% by mass), SnO₂ (manufactured by Mitsuwa Chemicals Co., Ltd., purity of 99.9%) and Nb₂O₅(manufactured by MITSUI MINING & SMELTING CO., LTD., purity of 99.9%) as raw materials, each raw material was weighed in stoichiometric amounts so that c and d were values set forth in Table 2.

### Example 118

The sintered body of the ion conductive solid including the oxide of Example 118 was produced in the same step as that in Example 101 except that using Li₂CO₃ (manufactured by NACALAI TESQUE, INC., purity of 99.0% by mass), H₃BO₃ (manufactured by KANTO CHEMICAL CO., INC., purity of 99.5%), Ho₂O₃ (manufactured by Kojundo Chemical Laboratory Co., Ltd., purity of 99.9% by mass), In₂O₃ (manufactured by Shinko Chemical Co., Ltd., purity of 99% by mass), Nb₂O₅(manufactured by MITSUI MINING & SMELTING CO., LTD., purity of 99.9%) and Ta₂O₅ (manufactured by KANTO CHEMICAL CO., INC., purity of 99% by mass) as raw materials, each raw material used in Examples as described above was weighed in stoichiometric amounts so that b and d were values set forth in Table 2.

### Example 119

The sintered body of the ion conductive solid including the oxide of Example 119 was produced in the same step as that in Example 101 except that using Li₂CO₃ (manufactured by NACALAI TESQUE, INC., purity of 99.0% by mass), H₃BO₃ (manufactured by KANTO CHEMICAL CO., INC., purity of 99.5%), Ho₂O₃ (manufactured by Kojundo Chemical Laboratory Co., Ltd., purity of 99.9% by mass), and Pr₂O₃ (manufactured by Shin-Etsu Chemical Co., Ltd., purity of 99.9% by mass) as raw materials, each raw material was weighed in stoichiometric amounts so that b was a value set forth in Table 2.

### Example 120

The sintered body of the ion conductive solid including the oxide of Example 120 was produced in the same step as that in Example 101 except that each raw material used in Examples as described above was weighed in stoichiometric amounts so that b and d were values set forth in Table 2.

### Example 121

The sintered body of the ion conductive solid including the oxide of Example 121 was produced in the same step as that in Example 101 except that using Li₂CO₃ (manufactured by NACALAI TESQUE, INC., purity of 99.0% by mass), H₃BO₃ (manufactured by KANTO CHEMICAL CO., INC., purity of 99.5%), Ho₂O₃ (manufactured by Kojundo Chemical Laboratory Co., Ltd., purity of 99.9% by mass), Sm₂O₃ (manufactured by Wako Pure Chemical Industries, Ltd., purity of 99.9% by mass), HfO₂ (manufactured by New Metals and Chemicals Corporation, Ltd., purity of 99.9%), and Ta₂O₅ (manufactured by KANTO CHEMICAL CO., INC., purity of 99% by mass) as raw materials, each raw material was weighed in stoichiometric amounts so that b, c, and d were values set forth in Table 2.

### Example 122

The sintered body of the ion conductive solid including the oxide of Example 122 was produced in the same step as that in Example 101 except that using Li₂CO₃ (manufactured by NACALAI TESQUE, INC., purity of 99.0% by mass), H₃BO₃ (manufactured by KANTO CHEMICAL CO., INC., purity of 99.5%), Ho₂O₃ (manufactured by Kojundo Chemical Laboratory Co., Ltd., purity of 99.9% by mass), Nd₂O₃(manufactured by Shin-Etsu Chemical Co., Ltd., purity of 99.9% by mass), Sm₂O₃ (manufactured by Wako Pure Chemical Industries, Ltd., purity of 99.9% by mass), and ZnO (manufactured by Wako Pure Chemical Industries, Ltd., purity of 99% by mass) as raw materials, each raw material was weighed in stoichiometric amounts so that a and b were values set forth in Table 2.

### Example 123

The sintered body of the ion conductive solid including the oxide of Example 123 was produced in the same step as that in Example 101 except that each raw material used in Examples as described above was weighed in stoichiometric amounts so that b and c were values set forth in Table 2.

### Example 124

The sintered body of the ion conductive solid including the oxide of Example 124 was produced in the same step as that in Example 101 except that using Li₂CO₃ (manufactured by NACALAI TESQUE, INC., purity of 99.0% by mass), H₃BO₃ (manufactured by KANTO CHEMICAL CO., INC., purity of 99.5%), Ho₂O₃ (manufactured by Kojundo Chemical Laboratory Co., Ltd., purity of 99.9% by mass), and Eu₂O₃ (manufactured by Shin-Etsu Chemical Co., Ltd., purity of 95% by mass) as raw materials, each raw material was weighed in stoichiometric amounts so that b was a value set forth in Table 2.

### Example 125

The sintered body of the ion conductive solid including the oxide of Example 125 was produced in the same step as that in Example 101 except that using Li₂CO₃ (manufactured by NACALAI TESQUE, INC., purity of 99.0% by mass), H₃BO₃ (manufactured by KANTO CHEMICAL CO., INC., purity of 99.5%), Ho₂O₃ (manufactured by Kojundo Chemical Laboratory Co., Ltd., purity of 99.9% by mass), Eu₂O₃ (manufactured by Shin-Etsu Chemical Co., Ltd., purity of 95% by mass), and NiO (manufactured by Wako Pure Chemical Industries, Ltd., purity of 99.0% by mass) as raw materials, each raw material was weighed in stoichiometric amounts so that a and b were values set forth in Table 2.

### Example 126

The sintered body of the ion conductive solid including the oxide of Example 126 was produced in the same step as that in Example 101 except that each raw material used in Examples as described above was weighed in stoichiometric amounts so that b and c were values set forth in Table 2.

### Example 127

The sintered body of the ion conductive solid including the oxide of Example 127 was produced in the same step as that in Example 101 except that using Li₂CO₃ (manufactured by NACALAI TESQUE, INC., purity of 99.0% by mass), H₃BO₃ (manufactured by KANTO CHEMICAL CO., INC., purity of 99.5%), Ho₂O₃ (manufactured by Kojundo Chemical Laboratory Co., Ltd., purity of 99.9% by mass), Gd₂O₃(manufactured by Shin-Etsu Chemical Co., Ltd., purity of 99.9% by mass), Dy₂O₃ (manufactured by Shin-Etsu Chemical Co., Ltd., purity of 95% by mass), and CaO (manufactured by KANTO CHEMICAL CO., INC., purity of 99.0% by mass) as raw materials, each raw material was weighed in stoichiometric amounts so that a and b were values set forth in Table 2.

### Example 128

The sintered body of the ion conductive solid including the oxide of Example 128 was produced in the same step as that in Example 101 except that each raw material used in Examples as described above was weighed in stoichiometric amounts so that b and c were values set forth in Table 2.

### Example 129

The sintered body of the ion conductive solid including the oxide of Example 129 was produced in the same step as that in Example 101 except that each raw material used in Examples as described above was weighed in stoichiometric amounts so that b and c were values set forth in Table 2.

### Example 130

The sintered body of the ion conductive solid including the oxide of Example 130 was produced in the same step as that in Example 101 except that each raw material used in Examples as described above was weighed in stoichiometric amounts so that b was a value set forth in Table 2.

### Example 131

The sintered body of the ion conductive solid including the oxide of Example 131 was produced in the same step as that in Example 101 except that using Li₂CO₃ (manufactured by NACALAI TESQUE, INC., purity of 99.0% by mass), H₃BO₃ (manufactured by KANTO CHEMICAL CO., INC., purity of 99.5%), Ho₂O₃ (manufactured by Kojundo Chemical Laboratory Co., Ltd., purity of 99.9% by mass), Tb₂O₃(manufactured by Shin-Etsu Chemical Co., Ltd., purity of 99.9% by mass), NiO (manufactured by Wako Pure Chemical Industries, Ltd., purity of 99.0% by mass), and BaO (manufactured by Wako Pure Chemical Industries, Ltd., purity of 90.0% by mass) as raw materials, each raw material was weighed in stoichiometric amounts so that a and b were values set forth in Table 2.

### Example 132

The sintered body of the ion conductive solid including the oxide of Example 132 was produced in the same step as that in Example 101 except that each raw material used in Examples as described above was weighed in stoichiometric amounts so that b, c, and d were values set forth in Table 2.

### Example 133

The sintered body of the ion conductive solid including the oxide of Example 133 was produced in the same step as that in Example 101 except that using Li₂CO₃ (manufactured by NACALAI TESQUE, INC., purity of 99.0% by mass), H₃BO₃ (manufactured by KANTO CHEMICAL CO., INC., purity of 99.5%), Ho₂O₃ (manufactured by Kojundo Chemical Laboratory Co., Ltd., purity of 99.9% by mass), Er₂O₃(manufactured by Shin-Etsu Chemical Co., Ltd., purity of 95% by mass), Tm₂O₃ (manufactured by Kojundo Chemical Laboratory Co., Ltd., purity of 99.9% by mass), and SrO (manufactured by Kojundo Chemical Laboratory Co., Ltd., purity of 98% by mass) as raw materials, each raw material was weighed in stoichiometric amounts so that a and b were values set forth in Table 2.

### Example 134

The sintered body of the ion conductive solid including the oxide of Example 134 was produced in the same step as that in Example 101 except that each raw material used in Examples as described above was weighed in stoichiometric amounts so that b and c were values set forth in Table 2.

### Example 135

The sintered body of the ion conductive solid including the oxide of Example 135 was produced in the same step as that in Example 101 except that each raw material used in Examples as described above was weighed in stoichiometric amounts so that a, b, and c were values set forth in Table 2.

### Example 136

The sintered body of the ion conductive solid including the oxide of Example 136 was produced in the same step as that in Example 101 except that each raw material used in Examples as described above was weighed in stoichiometric amounts so that b and d were values set forth in Table 2.

### Example 137

The sintered body of the ion conductive solid including the oxide of Example 137 was produced in the same step as that in Example 101 except that each raw material used in Examples as described above was weighed in stoichiometric amounts so that b, c, and d were values set forth in Table 2.

### Example 138

The sintered body of the ion conductive solid including the oxide of Example 138 was produced in the same step as that in Example 101 except that each raw material used in Examples as described above was weighed in stoichiometric amounts so that a, b, and c were values set forth in Table 2.

### Example 139

The sintered body of the ion conductive solid including the oxide of Example 139 was produced in the same step as that in Example 101 except that each raw material used in Examples as described above was weighed in stoichiometric amounts so that b and d were values set forth in Table 2.

### Example 140

The sintered body of the ion conductive solid including the oxide of Example 140 was produced in the same step as that in Example 101 except that each raw material used in Examples as described above was weighed in stoichiometric amounts so that b and d were values set forth in Table 2.

### Example 141

The sintered body of the ion conductive solid including the oxide of Example 141 was produced in the same step as that in Example 101 except that using Li₂CO₃ (manufactured by NACALAI TESQUE, INC., purity of 99.0% by mass), H₃BO₃ (manufactured by KANTO CHEMICAL CO., INC., purity of 99.5%), Ho₂O₃ (manufactured by Kojundo Chemical Laboratory Co., Ltd., purity of 99.9% by mass), and Sc₂O₃ (manufactured by Kojundo Chemical Laboratory Co., Ltd., purity of 99.9% by mass) as raw materials, each raw material was weighed in stoichiometric amounts so that b was a value set forth in Table 2.

### Example 142

The sintered body of the ion conductive solid including the oxide of Example 142 was produced in the same step as that in Example 101 except that each raw material used in Examples as described above was weighed in stoichiometric amounts so that a and b were values set forth in Table 2, and a disk rotation number in pulverization was set at 300 rpm.

### Example 143

The sintered body of the ion conductive solid including the oxide of Example 143 was produced in the same step as that in Example 101 except that each raw material used in Examples as described above was weighed in stoichiometric amounts so that a and b were values set forth in Table 2, and a disk rotation number in pulverization was set at 300 rpm.

### Example 144

The sintered body of the ion conductive solid including the oxide of Example 144 was produced in the same step as that in Example 101 except that each raw material used in Examples as described above was weighed in stoichiometric amounts so that a and b were values set forth in Table 2, and a disk rotation number in pulverization was set at 300 rpm.

### Example 201

### Primary Baking Step

Using Li₂CO₃ (manufactured by NACALAI TESQUE, INC., purity of 99.0% by mass), H₃BO₃ (manufactured by KANTO CHEMICAL CO., INC., purity of 99.5%), Er₂O₃ (manufactured by Shin-Etsu Chemical Co., Ltd., purity of 95% by mass), and Nb₂O₅(manufactured by MITSUI MINING & SMELTING CO., LTD., purity of 99.9%) as raw materials, each raw material was weighed in stoichiometric amounts so that d was a value set forth in Table 3, and was mixed in a planetary mill P-7 manufactured by Fritsch GmbH at a disk rotation number of 300 rpm for 30 minutes. A ball with a diameter of 5 mm, made of zirconia, and a 45 mL container were used in the planetary mill.

After the mixing, the mixed powder was cold uniaxially molded at 147 MPa using a 100 kN electrically operated press apparatus P3052-10 manufactured by NPa SYSTEM Co., Ltd., and baked in ambient atmosphere. The heating temperature was set at 650° C., and the retention time was set at 720 minutes.

The obtained ion conductive solid including the oxide was ground for 180 minutes at a disk rotation number of 230 rpm in the planetary mill P-7 manufactured by Fritsch GmbH, to produce the powder of the ion conductive solid including the oxide.

### Secondary Baking Step

The powder of the ion conductive solid including the oxide, obtained as described above, was molded and secondarily baked to produce a sintered body of the ion conductive solid including the oxide of Example 1. For the molding, the powder was cold uniaxially molded at 147 MPa using a 100 kN electrically operated press apparatus P3052-10 manufactured by NPa SYSTEM Co., Ltd. The secondary baking was performed in ambient atmosphere, the heating temperature was set at 650° C., and the retention time was set at 720 minutes.

### Example 202

The sintered body of the ion conductive solid including the oxide of Example 202 was produced in the same step as that in Example 201 except that using Li₂CO₃ (manufactured by NACALAI TESQUE, INC., purity of 99.0% by mass), H₃BO₃ (manufactured by KANTO CHEMICAL CO., INC., purity of 99.5%), Er₂O₃ (manufactured by Shin-Etsu Chemical Co., Ltd., purity of 95% by mass), and CeO₂ (manufactured by Shin-Etsu Chemical Co., Ltd., purity of 99.9%) as raw materials, each raw material was weighed in stoichiometric amounts so that c was a value set forth in Table 3.

### Example 203

The sintered body of the ion conductive solid including the oxide of Example 203 was produced in the same step as that in Example 201 except that using Li₂CO₃ (manufactured by NACALAI TESQUE, INC., purity of 99.0% by mass), H₃BO₃ (manufactured by KANTO CHEMICAL CO., INC., purity of 99.5%), Er₂O₃ (manufactured by Shin-Etsu Chemical Co., Ltd., purity of 95% by mass), ZrO₂ (manufactured by NIPPON DENKO CO., LTD., purity of 99.9%), CeO₂ (manufactured by Shin-Etsu Chemical Co., Ltd., purity of 99.9%) and Nb₂O₅ (manufactured by MITSUI MINING & SMELTING CO., LTD., purity of 99.9%) as raw materials, each raw material was weighed in stoichiometric amounts so that c and d were values set forth in Table 3.

### Example 204

The sintered body of the ion conductive solid including the oxide of Example 204 was produced in the same step as that in Example 201 except that each raw material used in Examples as described above was weighed in stoichiometric amounts so that values set forth in Table 3 were achieved.

### Example 205

The sintered body of the ion conductive solid including the oxide of Example 205 was produced in the same step as that in Example 201 except that using Li₂CO₃ (manufactured by NACALAI TESQUE, INC., purity of 99.0% by mass), H₃BO₃ (manufactured by KANTO CHEMICAL CO., INC., purity of 99.5%), Er₂O₃ (manufactured by Shin-Etsu Chemical Co., Ltd., purity of 95% by mass), and HfO₂ (manufactured by New Metals and Chemicals Corporation, Ltd., purity of 99.9%) as raw materials, each raw material was weighed in stoichiometric amounts so that c was a value set forth in Table 3.

### Example 206

The sintered body of the ion conductive solid including the oxide of Example 206 was produced in the same step as that in Example 201 except that each raw material used in Examples as described above was weighed in stoichiometric amounts so that c was a value set forth in Table 3.

### Example 207

The sintered body of the ion conductive solid including the oxide of Example 207 was produced in the same step as that in Example 201 except that each raw material used in Examples as described above was weighed in stoichiometric amounts so that c and d were values set forth in Table 3.

### Example 208

The sintered body of the ion conductive solid including the oxide of Example 208 was produced in the same step as that in Example 201 except that using Li₂CO₃ (manufactured by NACALAI TESQUE, INC., purity of 99.0% by mass), H₃BO₃ (manufactured by KANTO CHEMICAL CO., INC., purity of 99.5%), Er₂O₃ (manufactured by Shin-Etsu Chemical Co., Ltd., purity of 95% by mass), In₂O₃ (manufactured by Shinko Chemical Co., Ltd., purity of 99% by mass), and SnO₂ (manufactured by Mitsuwa Chemicals Co., Ltd., purity of 99.9%) as raw materials, each raw material was weighed in stoichiometric amounts so that b and c were values set forth in Table 3.

### Example 209

The sintered body of the ion conductive solid including the oxide of Example 209 was produced in the same step as that in Example 201 except that each raw material used in Examples as described above was weighed in stoichiometric amounts so that b and c were values set forth in Table 3.

### Example 210

The sintered body of the ion conductive solid including the oxide of Example 210 was produced in the same step as that in Example 201 except that using Li₂CO₃ (manufactured by NACALAI TESQUE, INC., purity of 99.0% by mass), H₃BO₃ (manufactured by KANTO CHEMICAL CO., INC., purity of 99.5%), Er₂O₃ (manufactured by Shin-Etsu Chemical Co., Ltd., purity of 95% by mass), Fe₂O₃ (manufactured by Wako Pure Chemical Industries, Ltd., purity of 95.0% by mass), and TiO₂ (manufactured by TOHO TITANIUM CO., LTD., purity of 99%) as raw materials, each raw material was weighed in stoichiometric amounts so that b and c were values set forth in Table 3.

### Example 211

The sintered body of the ion conductive solid including the oxide of Example 211 was produced in the same step as that in Example 201 except that each raw material used in Examples as described above was weighed in stoichiometric amounts so that b and c were values set forth in Table 3.

### Example 212

The sintered body of the ion conductive solid including the oxide of Example 212 was produced in the same step as that in Example 201 except that using Li₂CO₃ (manufactured by NACALAI TESQUE, INC., purity of 99.0% by mass), H₃BO₃ (manufactured by KANTO CHEMICAL CO., INC., purity of 99.5%), Er₂O₃ (manufactured by Shin-Etsu Chemical Co., Ltd., purity of 95% by mass), MgO (manufactured by Ube Material Industries, Ltd., purity of 99.0% by mass), and CeO₂ (manufactured by Shin-Etsu Chemical Co., Ltd., purity of 99.9%) as raw materials, each raw material was weighed in stoichiometric amounts so that a and c were values set forth in Table 3.

### Example 213

The sintered body of the ion conductive solid including the oxide of Example 213 was produced in the same step as that in Example 201 except that using Li₂CO₃ (manufactured by NACALAI TESQUE, INC., purity of 99.0% by mass), H₃BO₃ (manufactured by KANTO CHEMICAL CO., INC., purity of 99.5%), Er₂O₃ (manufactured by Shin-Etsu Chemical Co., Ltd., purity of 95% by mass), La₂O₃ (manufactured by Wako Pure Chemical Industries, Ltd., purity of 99.9% by mass), MgO (manufactured by Ube Material Industries, Ltd., purity of 99.0% by mass), and CaO (manufactured by KANTO CHEMICAL CO., INC., purity of 97.0% by mass) as raw materials, each raw material was weighed in stoichiometric amounts so that a and b were values set forth in Table 3.

### Example 214

The sintered body of the ion conductive solid including the oxide of Example 214 was produced in the same step as that in Example 201 except that using Li₂CO₃ (manufactured by NACALAI TESQUE, INC., purity of 99.0% by mass), H₃BO₃ (manufactured by KANTO CHEMICAL CO., INC., purity of 99.5%), Er₂O₃ (manufactured by Shin-Etsu Chemical Co., Ltd., purity of 95% by mass), Lu₂O₃ (manufactured by Kojundo Chemical Laboratory Co., Ltd., purity of 99.9% by mass), and MnO (manufactured by KANTO CHEMICAL CO., INC., purity of 80.0% by mass) as raw materials, each raw material was weighed in stoichiometric amounts so that a and b were values set forth in Table 3.

### Example 215

The sintered body of the ion conductive solid including the oxide of Example 215 was produced in the same step as that in Example 201 except that using Li₂CO₃ (manufactured by NACALAI TESQUE, INC., purity of 99.0% by mass), H₃BO₃ (manufactured by KANTO CHEMICAL CO., INC., purity of 99.5%), Er₂O₃ (manufactured by Shin-Etsu Chemical Co., Ltd., purity of 95% by mass), Tb₂O₃ (manufactured by Shin-Etsu Chemical Co., Ltd., purity of 99.9% by mass), and MnO (manufactured by KANTO CHEMICAL CO., INC., purity of 80.0% by mass) as raw materials, each raw material was weighed in stoichiometric amounts so that a and b were values set forth in Table 3.

### Example 216

The sintered body of the ion conductive solid including the oxide of Example 216 was produced in the same step as that in Example 201 except that using Li₂CO₃ (manufactured by NACALAI TESQUE, INC., purity of 99.0% by mass), H₃BO₃ (manufactured by KANTO CHEMICAL CO., INC., purity of 99.5%), Er₂O₃ (manufactured by Shin-Etsu Chemical Co., Ltd., purity of 95% by mass), Tm₂O₃ (manufactured by Kojundo Chemical Laboratory Co., Ltd., purity of 99.9% by mass), and MnO (manufactured by KANTO CHEMICAL CO., INC., purity of 80.0% by mass) as raw materials, each raw material was weighed in stoichiometric amounts so that a and b were values set forth in Table 3.

### Example 217

The sintered body of the ion conductive solid including the oxide of Example 217 was produced in the same step as that in Example 201 except that each raw material used in Examples as described above was weighed in stoichiometric amounts so that c and d were values set forth in Table 3.

### Example 218

The sintered body of the ion conductive solid including the oxide of Example 218 was produced in the same step as that in Example 201 except that using Li₂CO₃ (manufactured by NACALAI TESQUE, INC., purity of 99.0% by mass), H₃BO₃ (manufactured by KANTO CHEMICAL CO., INC., purity of 99.5%), Er₂O₃ (manufactured by Shin-Etsu Chemical Co., Ltd., purity of 95% by mass), In₂O₃ (manufactured by Shinko Chemical Co., Ltd., purity of 99% by mass), Nb₂O₅ (manufactured by MITSUI MINING & SMELTING CO., LTD., purity of 99.9%) and Ta₂O₅ (manufactured by KANTO CHEMICAL CO., INC., purity of 99% by mass) as raw materials, each raw material was weighed in stoichiometric amounts so that b and d were values set forth in Table 3.

### Example 219

The sintered body of the ion conductive solid including the oxide of Example 219 was produced in the same step as that in Example 201 except that using Li₂CO₃ (manufactured by NACALAI TESQUE, INC., purity of 99.0% by mass), H₃BO₃ (manufactured by KANTO CHEMICAL CO., INC., purity of 99.5%), Er₂O₃ (manufactured by Shin-Etsu Chemical Co., Ltd., purity of 95% by mass), and Pr₂O₃ (manufactured by Shin-Etsu Chemical Co., Ltd., purity of 99.9% by mass) as raw materials, each raw material was weighed in stoichiometric amounts so that b was a value set forth in Table 3.

### Example 220

The sintered body of the ion conductive solid including the oxide of Example 220 was produced in the same step as that in Example 201 except that each raw material used in Examples as described above was weighed in stoichiometric amounts so that b and d were values set forth in Table 3.

### Example 221

The sintered body of the ion conductive solid including the oxide of Example 221 was produced in the same step as that in Example 201 except that using Li₂CO₃ (manufactured by NACALAI TESQUE, INC., purity of 99.0% by mass), H₃BO₃ (manufactured by KANTO CHEMICAL CO., INC., purity of 99.5%), Er₂O₃ (manufactured by Shin-Etsu Chemical Co., Ltd., purity of 95% by mass), Sm₂O₃ (manufactured by Wako Pure Chemical Industries, Ltd., purity of 99.9% by mass), HfO₂ (manufactured by New Metals and Chemicals Corporation, Ltd., purity of 99.9%), and Ta₂O₅ (manufactured by KANTO CHEMICAL CO., INC., purity of 99% by mass) as raw materials, each raw material was weighed in stoichiometric amounts so that b, c, and d were values set forth in Table 3.

### Example 222

The sintered body of the ion conductive solid including the oxide of Example 222 was produced in the same step as that in Example 201 except that using Li₂CO₃ (manufactured by NACALAI TESQUE, INC., purity of 99.0% by mass), H₃BO₃ (manufactured by KANTO CHEMICAL CO., INC., purity of 99.5%), Er₂O₃ (manufactured by Shin-Etsu Chemical Co., Ltd., purity of 95% by mass), Nd₂O₃ (manufactured by Shin-Etsu Chemical Co., Ltd., purity of 99.9% by mass), Sm₂O₃ (manufactured by Wako Pure Chemical Industries, Ltd., purity of 99.9% by mass), and ZnO (manufactured by Wako Pure Chemical Industries, Ltd., purity of 99% by mass) as raw materials, each raw material was weighed in stoichiometric amounts so that a and b were values set forth in Table 3.

### Example 223

The sintered body of the ion conductive solid including the oxide of Example 223 was produced in the same step as that in Example 201 except that each raw material used in Examples as described above was weighed in stoichiometric amounts so that b and c were values set forth in Table 3.

### Example 224

The sintered body of the ion conductive solid including the oxide of Example 224 was produced in the same step as that in Example 201 except that using Li₂CO₃ (manufactured by NACALAI TESQUE, INC., purity of 99.0% by mass), H₃BO₃ (manufactured by KANTO CHEMICAL CO., INC., purity of 99.5%), Er₂O₃ (manufactured by Shin-Etsu Chemical Co., Ltd., purity of 95% by mass), and Eu₂O₃ (manufactured by Shin-Etsu Chemical Co., Ltd., purity of 95% by mass) as raw materials, each raw material was weighed in stoichiometric amounts so that b was a value set forth in Table 3.

### Example 225

The sintered body of the ion conductive solid including the oxide of Example 225 was produced in the same step as that in Example 201 except that using Li₂CO₃ (manufactured by NACALAI TESQUE, INC., purity of 99.0% by mass), H₃BO₃ (manufactured by KANTO CHEMICAL CO., INC., purity of 99.5%), Er₂O₃ (manufactured by Shin-Etsu Chemical Co., Ltd., purity of 95% by mass), Eu₂O₃ (manufactured by Shin-Etsu Chemical Co., Ltd., purity of 95% by mass), and NiO (manufactured by Wako Pure Chemical Industries, Ltd., purity of 99.0% by mass) as raw materials, each raw material was weighed in stoichiometric amounts so that a and b were values set forth in Table 3.

### Example 226

The sintered body of the ion conductive solid including the oxide of Example 226 was produced in the same step as that in Example 201 except that each raw material used in Examples as described above was weighed in stoichiometric amounts so that b and c were values set forth in Table 3.

### Example 227

The sintered body of the ion conductive solid including the oxide of Example 227 was produced in the same step as that in Example 201 except that using Li₂CO₃ (manufactured by NACALAI TESQUE, INC., purity of 99.0% by mass), H₃BO₃ (manufactured by KANTO CHEMICAL CO., INC., purity of 99.5%), Er₂O₃ (manufactured by Shin-Etsu Chemical Co., Ltd., purity of 95% by mass), Gd₂O₃ (manufactured by Shin-Etsu Chemical Co., Ltd., purity of 99.9% by mass), Dy₂O₃ (manufactured by Shin-Etsu Chemical Co., Ltd., purity of 95% by mass), and CaO (manufactured by KANTO CHEMICAL CO., INC., purity of 99.0% by mass) as raw materials, each raw material was weighed in stoichiometric amounts so that a and b were values set forth in Table 3.

### Example 228

The sintered body of the ion conductive solid including the oxide of Example 228 was produced in the same step as that in Example 201 except that each raw material used in Examples as described above was weighed in stoichiometric amounts so that b and c were values set forth in Table 3.

### Example 229

The sintered body of the ion conductive solid including the oxide of Example 229 was produced in the same step as that in Example 201 except that each raw material used in Examples as described above was weighed in stoichiometric amounts so that b and c were values set forth in Table 3.

### Example 230

The sintered body of the ion conductive solid including the oxide of Example 230 was produced in the same step as that in Example 201 except that each raw material used in Examples as described above was weighed in stoichiometric amounts so that b was a value set forth in Table 3.

### Example 231

The sintered body of the ion conductive solid including the oxide of Example 231 was produced in the same step as that in Example 201 except that using Li₂CO₃ (manufactured by NACALAI TESQUE, INC., purity of 99.0% by mass), H₃BO₃ (manufactured by KANTO CHEMICAL CO., INC., purity of 99.5%), Er₂O₃ (manufactured by Shin-Etsu Chemical Co., Ltd., purity of 95% by mass), Tb₂O₃ (manufactured by Shin-Etsu Chemical Co., Ltd., purity of 99.9% by mass), NiO (manufactured by Wako Pure Chemical Industries, Ltd., purity of 99.0% by mass), and BaO (manufactured by Wako Pure Chemical Industries, Ltd., purity of 90.0% by mass) as raw materials, each raw material was weighed in stoichiometric amounts so that a and b were values set forth in Table 3.

### Example 232

The sintered body of the ion conductive solid including the oxide of Example 232 was produced in the same step as that in Example 201 except that using Li₂CO₃ (manufactured by NACALAI TESQUE, INC., purity of 99.0% by mass), H₃BO₃ (manufactured by KANTO CHEMICAL CO., INC., purity of 99.5%), Er₂O₃ (manufactured by Shin-Etsu Chemical Co., Ltd., purity of 95% by mass), Ho₂O₃ (manufactured by Kojundo Chemical Laboratory Co., Ltd., purity of 99.9% by mass), Tb₂O₃(manufactured by Shin-Etsu Chemical Co., Ltd., purity of 99.9% by mass), and SrO (manufactured by Kojundo Chemical Laboratory Co., Ltd., purity of 98% by mass) as raw materials, each raw material was weighed in stoichiometric amounts so that a and b were values set forth in Table 3.

### Example 233

The sintered body of the ion conductive solid including the oxide of Example 233 was produced in the same step as that in Example 201 except that each raw material used in Examples as described above was weighed in stoichiometric amounts so that b, c, and d were values set forth in Table 3.

### Example 234

The sintered body of the ion conductive solid including the oxide of Example 234 was produced in the same step as that in Example 201 except that each raw material used in Examples as described above was weighed in stoichiometric amounts so that b and d were values set forth in Table 3.

### Example 235

The sintered body of the ion conductive solid including the oxide of Example 235 was produced in the same step as that in Example 201 except that each raw material used in Examples as described above was weighed in stoichiometric amounts so that b, c, and d were values set forth in Table 3.

### Example 236

The sintered body of the ion conductive solid including the oxide of Example 236 was produced in the same step as that in Example 201 except that each raw material used in Examples as described above was weighed in stoichiometric amounts so that a, b, and c were values set forth in Table 3.

### Example 237

The sintered body of the ion conductive solid including the oxide of Example 237 was produced in the same step as that in Example 201 except that each raw material used in Examples as described above was weighed in stoichiometric amounts so that b and d were values set forth in Table 3.

### Example 238

The sintered body of the ion conductive solid including the oxide of Example 238 was produced in the same step as that in Example 201 except that each raw material used in Examples as described above was weighed in stoichiometric amounts so that b and d were values set forth in Table 3.

### Example 239

The sintered body of the ion conductive solid including the oxide of Example 239 was produced in the same step as that in Example 201 except that using Li₂CO₃ (manufactured by NACALAI TESQUE, INC., purity of 99.0% by mass), H₃BO₃ (manufactured by KANTO CHEMICAL CO., INC., purity of 99.5%), Er₂O₃ (manufactured by Shin-Etsu Chemical Co., Ltd., purity of 95% by mass), and Sc₂O₃ (manufactured by Kojundo Chemical Laboratory Co., Ltd., purity of 99.9% by mass) as raw materials, each raw material was weighed in stoichiometric amounts so that b was a value set forth in Table 3.

### Example 240

The sintered body of the ion conductive solid including the oxide of Example 240 was produced in the same step as that in Example 201 except that each raw material used in Examples as described above was weighed in stoichiometric amounts so that a and b were values set forth in Table 3, and a disk rotation number in pulverization was set at 300 rpm.

### Example 241

The sintered body of the ion conductive solid including the oxide of Example 241 was produced in the same step as that in Example 201 except that each raw material used in Examples as described above was weighed in stoichiometric amounts so that a and b were values set forth in Table 3, and a disk rotation number in pulverization was set at 300 rpm.

### Example 242

The sintered body of the ion conductive solid including the oxide of Example 242 was produced in the same step as that in Example 201 except that each raw material used in Examples as described above was weighed in stoichiometric amounts so that a and b were values set forth in Table 3, and a disk rotation number in pulverization was set at 300 rpm.

### Example 301

### Primary Baking Step

Using Li₂CO₃ (manufactured by NACALAI TESQUE, INC., purity of 99.0% by mass), H₃BO₃ (manufactured by KANTO CHEMICAL CO., INC., purity of 99.5%), Tm₂O₃ (manufactured by Kojundo Chemical Laboratory Co., Ltd., purity of 99.9% by mass), and Nb₂O₅(manufactured by MITSUI MINING & SMELTING CO., LTD., purity of 99.9%) as raw materials, each raw material was weighed in stoichiometric amounts so that d was a value set forth in Table 4, and was mixed in a planetary mill P-7 manufactured by Fritsch GmbH at a disk rotation number of 300 rpm for 30 minutes. A ball with a diameter of 5 mm, made of zirconia, and a 45 mL container were used in the planetary mill.

After the mixing, the mixed powder was cold uniaxially molded at 147 MPa using a 100 kN electrically operated press apparatus P3052-10 manufactured by NPa SYSTEM Co., Ltd., and baked in ambient atmosphere. The heating temperature was set at 650° C., and the retention time was set at 720 minutes.

The obtained ion conductive solid including the oxide was ground for 180 minutes at a disk rotation number of 230 rpm in the planetary mill P-7 manufactured by Fritsch GmbH, to produce the powder of the ion conductive solid including the oxide.

### Secondary Baking Step

The powder of the ion conductive solid including the oxide, obtained as described above, was molded and secondarily baked to produce a sintered body of the ion conductive solid including the oxide of Example 301. For the molding, the powder was cold uniaxially molded at 147 MPa using a 100 kN electrically operated press apparatus P3052-10 manufactured by NPa SYSTEM Co., Ltd. The secondary baking was performed in ambient atmosphere, the heating temperature was set at 650° C., and the retention time was set at 720 minutes.

### Example 302

The sintered body of the ion conductive solid including the oxide of Example 302 was produced in the same step as that in Example 301 except that using Li₂CO₃ (manufactured by NACALAI TESQUE, INC., purity of 99.0% by mass), H₃BO₃ (manufactured by KANTO CHEMICAL CO., INC., purity of 99.5%), Tm₂O₃ (manufactured by Kojundo Chemical Laboratory Co., Ltd., purity of 99.9% by mass), and CeO₂ (manufactured by Shin-Etsu Chemical Co., Ltd., purity of 99.9%) as raw materials, each raw material was weighed in stoichiometric amounts so that c was a value set forth in Table 4.

### Example 303

The sintered body of the ion conductive solid including the oxide of Example 303 was produced in the same step as that in Example 301 except that using Li₂CO₃ (manufactured by NACALAI TESQUE, INC., purity of 99.0% by mass), H₃BO₃ (manufactured by KANTO CHEMICAL CO., INC., purity of 99.5%), Tm₂O₃ (manufactured by Kojundo Chemical Laboratory Co., Ltd., purity of 99.9% by mass), ZrO₂ (manufactured by NIPPON DENKO CO., LTD., purity of 99.9%), CeO₂ (manufactured by Shin-Etsu Chemical Co., Ltd., purity of 99.9%), and Nb₂O₅ (manufactured by MITSUI MINING & SMELTING CO., LTD., purity of 99.9%) as raw materials, each raw material was weighed in stoichiometric amounts so that c and d were values set forth in Table 4.

### Example 304

The sintered body of the ion conductive solid including the oxide of Example 304 was produced in the same step as that in Example 301 except that each raw material used in Examples as described above was weighed in stoichiometric amounts so that values set forth in Table 4 were achieved.

### Example 305

The sintered body of the ion conductive solid including the oxide of Example 305 was produced in the same step as that in Example 301 except that using Li₂CO₃ (manufactured by NACALAI TESQUE, INC., purity of 99.0% by mass), H₃BO₃ (manufactured by KANTO CHEMICAL CO., INC., purity of 99.5%), Tm₂O₃ (manufactured by Kojundo Chemical Laboratory Co., Ltd., purity of 99.9% by mass), and HfO₂ (manufactured by New Metals and Chemicals Corporation, Ltd., purity of 99.9%) as raw materials, each raw material was weighed in stoichiometric amounts so that c was a value set forth in Table 4.

### Example 306

The sintered body of the ion conductive solid including the oxide of Example 306 was produced in the same step as that in Example 301 except that each raw material used in Examples as described above was weighed in stoichiometric amounts so that c was a value set forth in Table 4.

### Example 307

The sintered body of the ion conductive solid including the oxide of Example 307 was produced in the same step as that in Example 301 except that each raw material used in Examples as described above was weighed in stoichiometric amounts so that c and d were values set forth in Table 4.

### Example 308

The sintered body of the ion conductive solid including the oxide of Example 308 was produced in the same step as that in Example 301 except that using Li₂CO₃ (manufactured by NACALAI TESQUE, INC., purity of 99.0% by mass), H₃BO₃ (manufactured by KANTO CHEMICAL CO., INC., purity of 99.5%), Tm₂O₃ (manufactured by Kojundo Chemical Laboratory Co., Ltd., purity of 99.9% by mass), In₂O₃ (manufactured by Shinko Chemical Co., Ltd., purity of 99% by mass), and SnO₂ (manufactured by Mitsuwa Chemicals Co., Ltd., purity of 99.9%) as raw materials, each raw material was weighed in stoichiometric amounts so that b and c were values set forth in Table 4.

### Example 309

The sintered body of the ion conductive solid including the oxide of Example 309 was produced in the same step as that in Example 301 except that each raw material used in Examples as described above was weighed in stoichiometric amounts so that b and c were values set forth in Table 4.

### Example 310

The sintered body of the ion conductive solid including the oxide of Example 310 was produced in the same step as that in Example 301 except that using Li₂CO₃ (manufactured by NACALAI TESQUE, INC., purity of 99.0% by mass), H₃BO₃ (manufactured by KANTO CHEMICAL CO., INC., purity of 99.5%), Tm₂O₃ (manufactured by Kojundo Chemical Laboratory Co., Ltd., purity of 99.9% by mass), Fe₂O₃ (manufactured by Wako Pure Chemical Industries, Ltd., purity of 95.0% by mass), and TiO₂ (manufactured by TOHO TITANIUM CO., LTD., purity of 99%) as raw materials, each raw material was weighed in stoichiometric amounts so that b and c were values set forth in Table 4.

### Example 311

The sintered body of the ion conductive solid including the oxide of Example 311 was produced in the same step as that in Example 301 except that each raw material used in Examples as described above was weighed in stoichiometric amounts so that b and c were values set forth in Table 4.

### Example 312

The sintered body of the ion conductive solid including the oxide of Example 312 was produced in the same step as that in Example 301 except that using Li₂CO₃ (manufactured by NACALAI TESQUE, INC., purity of 99.0% by mass), H₃BO₃ (manufactured by KANTO CHEMICAL CO., INC., purity of 99.5%), Tm₂O₃ (manufactured by Kojundo Chemical Laboratory Co., Ltd., purity of 99.9% by mass), MgO (manufactured by Ube Material Industries, Ltd., purity of 99.0% by mass), and CeO₂ (manufactured by Shin-Etsu Chemical Co., Ltd., purity of 99.9%) as raw materials, each raw material was weighed in stoichiometric amounts so that a and c were values set forth in Table 4.

### Example 313

The sintered body of the ion conductive solid including the oxide of Example 313 was produced in the same step as that in Example 301 except that using Li₂CO₃ (manufactured by NACALAI TESQUE, INC., purity of 99.0% by mass), H₃BO₃ (manufactured by KANTO CHEMICAL CO., INC., purity of 99.5%), Tm₂O₃ (manufactured by Kojundo Chemical Laboratory Co., Ltd., purity of 99.9% by mass), La₂O₃ (manufactured by Wako Pure Chemical Industries, Ltd., purity of 99.9% by mass), MgO (manufactured by Ube Material Industries, Ltd., purity of 99.0% by mass), and CaO (manufactured by KANTO CHEMICAL CO., INC., purity of 97.0% by mass) as raw materials, each raw material was weighed in stoichiometric amounts so that a and b were values set forth in Table 4.

### Example 314

The sintered body of the ion conductive solid including the oxide of Example 314 was produced in the same step as that in Example 301 except that using Li₂CO₃ (manufactured by NACALAI TESQUE, INC., purity of 99.0% by mass), H₃BO₃ (manufactured by KANTO CHEMICAL CO., INC., purity of 99.5%), Tm₂O₃ (manufactured by Kojundo Chemical Laboratory Co., Ltd., purity of 99.9% by mass), Lu₂O₃ (manufactured by Kojundo Chemical Laboratory Co., Ltd., purity of 99.9% by mass), and MnO (manufactured by KANTO CHEMICAL CO., INC., purity of 80.0% by mass) as raw materials, each raw material was weighed in stoichiometric amounts so that a and b were values set forth in Table 4.

### Example 315

The sintered body of the ion conductive solid including the oxide of Example 315 was produced in the same step as that in Example 301 except that using Li₂CO₃ (manufactured by NACALAI TESQUE, INC., purity of 99.0% by mass), H₃BO₃ (manufactured by KANTO CHEMICAL CO., INC., purity of 99.5%), Tm₂O₃ (manufactured by Kojundo Chemical Laboratory Co., Ltd., purity of 99.9% by mass), Tb₂O₃(manufactured by Shin-Etsu Chemical Co., Ltd., purity of 99.9% by mass), and MnO (manufactured by KANTO CHEMICAL CO., INC., purity of 80.0% by mass) as raw materials, each raw material was weighed in stoichiometric amounts so that a and b were values set forth in Table 4.

### Example 316

The sintered body of the ion conductive solid including the oxide of Example 316 was produced in the same step as that in Example 301 except that each raw material used in Examples as described above was weighed in stoichiometric amounts so that c and d were values set forth in Table 4.

### Example 317

The sintered body of the ion conductive solid including the oxide of Example 317 was produced in the same step as that in Example 301 except that using Li₂CO₃ (manufactured by NACALAI TESQUE, INC., purity of 99.0% by mass), H₃BO₃ (manufactured by KANTO CHEMICAL CO., INC., purity of 99.5%), Tm₂O₃ (manufactured by Kojundo Chemical Laboratory Co., Ltd., purity of 99.9% by mass), In₂O₃ (manufactured by Shinko Chemical Co., Ltd., purity of 99% by mass), Nb₂O₅(manufactured by MITSUI MINING & SMELTING CO., LTD., purity of 99.9%), and Ta₂O₅(manufactured by KANTO CHEMICAL CO., INC., purity of 99% by mass) as raw materials, each raw material was weighed in stoichiometric amounts so that b and d were values set forth in Table 4.

### Example 318

The sintered body of the ion conductive solid including the oxide of Example 318 was produced in the same step as that in Example 301 except that using Li₂CO₃ (manufactured by NACALAI TESQUE, INC., purity of 99.0% by mass), H₃BO₃ (manufactured by KANTO CHEMICAL CO., INC., purity of 99.5%), Tm₂O₃ (manufactured by Kojundo Chemical Laboratory Co., Ltd., purity of 99.9% by mass), and Pr₂O₃ (manufactured by Shin-Etsu Chemical Co., Ltd., purity of 99.9% by mass) as raw materials, each raw material was weighed in stoichiometric amounts so that b was a value set forth in Table 4.

### Example 319

The sintered body of the ion conductive solid including the oxide of Example 319 was produced in the same step as that in Example 301 except that each raw material used in Examples as described above was weighed in stoichiometric amounts so that b and d were values set forth in Table 4.

### Example 320

The sintered body of the ion conductive solid including the oxide of Example 320 was produced in the same step as that in Example 301 except that using Li₂CO₃ (manufactured by NACALAI TESQUE, INC., purity of 99.0% by mass), H₃BO₃ (manufactured by KANTO CHEMICAL CO., INC., purity of 99.5%), Tm₂O₃ (manufactured by Kojundo Chemical Laboratory Co., Ltd., purity of 99.9% by mass), Sm₂O₃ (manufactured by Wako Pure Chemical Industries, Ltd., purity of 99.9% by mass), HfO₂ (manufactured by New Metals and Chemicals Corporation, Ltd., purity of 99.9%), and Ta₂O₅ (manufactured by KANTO CHEMICAL CO., INC., purity of 99% by mass) as raw materials, each raw material was weighed in stoichiometric amounts so that b, c, and d were values set forth in Table 4.

### Example 321

The sintered body of the ion conductive solid including the oxide of Example 321 was produced in the same step as that in Example 301 except that using Li₂CO₃ (manufactured by NACALAI TESQUE, INC., purity of 99.0% by mass), H₃BO₃ (manufactured by KANTO CHEMICAL CO., INC., purity of 99.5%), Tm₂O₃ (manufactured by Kojundo Chemical Laboratory Co., Ltd., purity of 99.9% by mass), Nd₂O₃(manufactured by Shin-Etsu Chemical Co., Ltd., purity of 99.9% by mass), Sm₂O₃ (manufactured by Wako Pure Chemical Industries, Ltd., purity of 99.9% by mass), and ZnO (manufactured by Wako Pure Chemical Industries, Ltd., purity of 99% by mass) as raw materials, each raw material was weighed in stoichiometric amounts so that a and b were values set forth in Table 4.

### Example 322

The sintered body of the ion conductive solid including the oxide of Example 322 was produced in the same step as that in Example 301 except that each raw material used in Examples as described above was weighed in stoichiometric amounts so that b and c were values set forth in Table 4.

### Example 323

The sintered body of the ion conductive solid including the oxide of Example 323 was produced in the same step as that in Example 301 except that using Li₂CO₃ (manufactured by NACALAI TESQUE, INC., purity of 99.0% by mass), H₃BO₃ (manufactured by KANTO CHEMICAL CO., INC., purity of 99.5%), Tm₂O₃ (manufactured by Kojundo Chemical Laboratory Co., Ltd., purity of 99.9% by mass), and Eu₂O₃ (manufactured by Shin-Etsu Chemical Co., Ltd., purity of 95% by mass) as raw materials, each raw material was weighed in stoichiometric amounts so that b was a value set forth in Table 4.

### Example 324

The sintered body of the ion conductive solid including the oxide of Example 324 was produced in the same step as that in Example 301 except that using Li₂CO₃ (manufactured by NACALAI TESQUE, INC., purity of 99.0% by mass), H₃BO₃ (manufactured by KANTO CHEMICAL CO., INC., purity of 99.5%), Tm₂O₃ (manufactured by Kojundo Chemical Laboratory Co., Ltd., purity of 99.9% by mass), Eu₂O₃ (manufactured by Shin-Etsu Chemical Co., Ltd., purity of 95% by mass), and NiO (manufactured by Wako Pure Chemical Industries, Ltd., purity of 99.0% by mass) as raw materials, each raw material was weighed in stoichiometric amounts so that a and b were values set forth in Table 4.

### Example 325

The sintered body of the ion conductive solid including the oxide of Example 325 was produced in the same step as that in Example 301 except that each raw material used in Examples as described above was weighed in stoichiometric amounts so that b and c were values set forth in Table 4.

### Example 326

The sintered body of the ion conductive solid including the oxide of Example 326 was produced in the same step as that in Example 301 except that using Li₂CO₃ (manufactured by NACALAI TESQUE, INC., purity of 99.0% by mass), H₃BO₃ (manufactured by KANTO CHEMICAL CO., INC., purity of 99.5%), Tm₂O₃ (manufactured by Kojundo Chemical Laboratory Co., Ltd., purity of 99.9% by mass), Gd₂O₃(manufactured by Shin-Etsu Chemical Co., Ltd., purity of 99.9% by mass), Dy₂O₃(manufactured by Shin-Etsu Chemical Co., Ltd., purity of 95% by mass), and CaO (manufactured by KANTO CHEMICAL CO., INC., purity of 99.0% by mass) as raw materials, each raw material was weighed in stoichiometric amounts so that a and b were values set forth in Table 4.

### Example 327

The sintered body of the ion conductive solid including the oxide of Example 327 was produced in the same step as that in Example 301 except that each raw material used in Examples as described above was weighed in stoichiometric amounts so that b and c were values set forth in Table 4.

### Example 328

The sintered body of the ion conductive solid including the oxide of Example 328 was produced in the same step as that in Example 301 except that each raw material used in Examples as described above was weighed in stoichiometric amounts so that b and c were values set forth in Table 4.

### Example 329

The sintered body of the ion conductive solid including the oxide of Example 329 was produced in the same step as that in Example 301 except that each raw material used in Examples as described above was weighed in stoichiometric amounts so that b was a value set forth in Table 4.

### Example 330

The sintered body of the ion conductive solid including the oxide of Example 330 was produced in the same step as that in Example 301 except that using Li₂CO₃ (manufactured by NACALAI TESQUE, INC., purity of 99.0% by mass), H₃BO₃ (manufactured by KANTO CHEMICAL CO., INC., purity of 99.5%), Tm₂O₃ (manufactured by Kojundo Chemical Laboratory Co., Ltd., purity of 99.9% by mass), Tb₂O₃(manufactured by Shin-Etsu Chemical Co., Ltd., purity of 99.9% by mass), NiO (manufactured by Wako Pure Chemical Industries, Ltd., purity of 99.0% by mass), and BaO (manufactured by Wako Pure Chemical Industries, Ltd., purity of 90.0% by mass) as raw materials, each raw material was weighed in stoichiometric amounts so that a and b were values set forth in Table 4.

### Example 331

The sintered body of the ion conductive solid including the oxide of Example 331 was produced in the same step as that in Example 301 except that using Li₂CO₃ (manufactured by NACALAI TESQUE, INC., purity of 99.0% by mass), H₃BO₃ (manufactured by KANTO CHEMICAL CO., INC., purity of 99.5%), Tm₂O₃ (manufactured by Kojundo Chemical Laboratory Co., Ltd., purity of 99.9% by mass), Tb₂O₃(manufactured by Shin-Etsu Chemical Co., Ltd., purity of 99.9% by mass), Ho₂O₃ (manufactured by Kojundo Chemical Laboratory Co., Ltd., purity of 99.9% by mass), and BaO (manufactured by Wako Pure Chemical Industries, Ltd., purity of 90.0% by mass) as raw materials, each raw material was weighed in stoichiometric amounts so that a and b were values set forth in Table 4.

### Example 332

The sintered body of the ion conductive solid including the oxide of Example 332 was produced in the same step as that in Example 301 except that each raw material used in Examples as described above was weighed in stoichiometric amounts so that b, c, and d were values set forth in Table 4.

### Example 333

The sintered body of the ion conductive solid including the oxide of Example 333 was produced in the same step as that in Example 301 except that using Li₂CO₃ (manufactured by NACALAI TESQUE, INC., purity of 99.0% by mass), H₃BO₃ (manufactured by KANTO CHEMICAL CO., INC., purity of 99.5%), Tm₂O₃ (manufactured by Kojundo Chemical Laboratory Co., Ltd., purity of 99.9% by mass), Ho₂O₃ (manufactured by Kojundo Chemical Laboratory Co., Ltd., purity of 99.9% by mass), Er₂O₃ (manufactured by Shin-Etsu Chemical Co., Ltd., purity of 95% by mass), and SrO (manufactured by Kojundo Chemical Laboratory Co., Ltd., purity of 98% by mass) as raw materials, each raw material was weighed in stoichiometric amounts so that a and b were values set forth in Table 4.

### Example 334

The sintered body of the ion conductive solid including the oxide of Example 334 was produced in the same step as that in Example 301 except that each raw material used in Examples as described above was weighed in stoichiometric amounts so that b and c were values set forth in Table 4.

### Example 335

The sintered body of the ion conductive solid including the oxide of Example 335 was produced in the same step as that in Example 301 except that each raw material used in Examples as described above was weighed in stoichiometric amounts so that a, b, and c were values set forth in Table 4.

### Example 336

The sintered body of the ion conductive solid including the oxide of Example 336 was produced in the same step as that in Example 301 except that each raw material used in Examples as described above was weighed in stoichiometric amounts so that a, b, and c were values set forth in Table 4.

### Example 337

The sintered body of the ion conductive solid including the oxide of Example 337 was produced in the same step as that in Example 301 except that each raw material used in Examples as described above was weighed in stoichiometric amounts so that b and d were values set forth in Table 4.

### Example 338

The sintered body of the ion conductive solid including the oxide of Example 338 was produced in the same step as that in Example 301 except that each raw material used in Examples as described above was weighed in stoichiometric amounts so that b and d were values set forth in Table 4.

### Example 339

The sintered body of the ion conductive solid including the oxide of Example 339 was produced in the same step as that in Example 301 except that using Li₂CO₃ (manufactured by NACALAI TESQUE, INC., purity of 99.0% by mass), H₃BO₃ (manufactured by KANTO CHEMICAL CO., INC., purity of 99.5%), Tm₂O₃ (manufactured by Kojundo Chemical Laboratory Co., Ltd., purity of 99.9% by mass), and Sc₂O₃ (manufactured by Kojundo Chemical Laboratory Co., Ltd., purity of 99.9% by mass) as raw materials, each raw material was weighed in stoichiometric amounts so that b was a value set forth in Table 4.

### Example 340

The sintered body of the ion conductive solid including the oxide of Example 340 was produced in the same step as that in Example 301 except that each raw material used in Examples as described above was weighed in stoichiometric amounts so that a and b were values set forth in Table 4, and a disk rotation number in pulverization was set at 300 rpm.

### Example 341

The sintered body of the ion conductive solid including the oxide of Example 341 was produced in the same step as that in Example 301 except that each raw material used in Examples as described above was weighed in stoichiometric amounts so that a and b were values set forth in Table 4, and a disk rotation number in pulverization was set at 300 rpm.

### Example 342

The sintered body of the ion conductive solid including the oxide of Example 342 was produced in the same step as that in Example 301 except that each raw material used in Examples as described above was weighed in stoichiometric amounts so that a and b were values set forth in Table 4, and a disk rotation number in pulverization was set at 300 rpm.

### Comparative Example 4

Tm₂O₃ as a raw material in Example 4 was changed to Sc₂O₃ (ionic radius of Sc³⁺: 0.87 Å) and production was performed in the same step as in Example 4, but the same crystal structure as in Example 4 could not be obtained. The impedance of the resulting sintered body was measured by a method described below, but the resistance of the sintered body could not be measured and the ionic conductivity was not obtained as a numerical value.

### Comparative Example 5

Tm₂O₃ as a raw material in Example 4 was changed to Fe₂O₃ (ionic radius of Fe³⁺: 0.78 Å) and production was performed in the same step as in Example 4, but the same crystal structure as in Example 4 could not be obtained. The impedance of the resulting sintered body was measured by a method described below, but the resistance of the sintered body could not be measured and the ionic conductivity was not obtained as a numerical value.

### Comparative Example 6

Tm₂O₃ as a raw material in Example 4 was changed to La₂O₃ (ionic radius of La³⁺. 1.16 Å), and production was performed in the same step as in Example 4, but the same crystal structure as in Example 4 could not be obtained. The impedance of the resulting sintered body was measured by a method described below, but the resistance of the sintered body could not be measured and the ionic conductivity was not obtained as a numerical value.

The sintered bodies of the ion conductive solids including the oxides of Examples 1 to 47, 101 to 144, 201 to 242 and 301 to 342 were subjected to composition analysis by the methods described above. Moreover, the volume mean particle diameters of the powders of the ion conductive solids obtained in Examples 1 to 47, 101 to 144, 201 to 242 and 301 to 342, and Comparative Examples 1 to 3, and the ionic conductivities of the sintered bodies of the ion conductive solids were measured by the following methods.

The methods of measuring the ionic conductivities and the volume mean particle diameters are described below. Moreover, the obtained evaluation results are set forth in Table 1, Table 2, Table 3, and Table 4.

### Measurement of Ionic Conductivity

Two surfaces, facing each other in parallel and having a large area, of the sintered body of the ion conductive solid including the oxide, obtained in the secondary baking and having a flat plate shape, were polished with sandpaper. The size of the sintered body of the ion conductive solid including the oxide, having the flat plate shape, can be set at, for example, 0.9 cm×0.9 cm×0.05 cm, but is not limited thereto. The polishing was performed, first with #500 for 15 minutes to 30 minutes, then with #1000 for 10 minutes to 20 minutes, and finally with #2000 for 5 minutes to 10 minutes, and was completed when neither conspicuous recess/projection nor flaw was visually observed on the polished surfaces.

After the polishing, gold was deposited on the polished surfaces of the sintered body of the ion conductive solid including the oxide using a sputtering apparatus SC-701MkII ADVANCE manufactured by Sanyu Electron Co., Ltd. A measurement sample was made in which as deposition conditions, a process gas was Ar, a vacuum degree was set at 2 Pa to 5 Pa, and deposition time was set at 5 minutes. After the deposition, the alternating-current impedance of the measurement sample was measured.

An impedance/gain phase analyzer SI1260 and a dielectric interface system 1296 (both of which were manufactured by Solartron) were used in the measurement of the impedance, and the conditions of the measurement were set at a temperature of 27° C., an amplitude of 20 mV, and a frequency of 0.1 Hz to 1 MHz.

The resistance of the sintered body of the ion conductive solid including the oxide was calculated using a Nyquist plot obtained in the impedance measurement, and alternating current analysis software ZVIEW manufactured by Scribner. An equivalent circuit corresponding to the measurement sample was set by ZVIEW, and the fitting and analysis of the equivalent circuit and the Nyquist plot were performed to calculate the resistance of the sintered body of the ion conductive solid including the oxide. The ionic conductivity was calculated from the following equation using the calculated resistance, the thickness of the sintered body of the ion conductive solid including the oxide, and an electrode area.

Ionic conductivity (S/cm)=thickness (cm) of sintered body of ion conductive solid including oxide/(resistance (Ω) of sintered body of ion conductive solid including oxide×electrode area (cm²))

The ionic conductivity (S/cm) of the sintered body of the ion conductive solid is, for example, preferably 8.00×10⁻⁹ or more, more preferably 1.00×10⁻⁸ or more, still more preferably 1.00×10⁻⁷ or more, even more preferably 1.00×10⁻⁶ or more, and particularly preferably 1.00×10⁻⁵ or more. The more conductivity is preferable, and the upper limit thereof is not particularly limited, and is, for example, 1.00×10⁻² or less, 1.00×10⁻³ or less, and 1.00×10⁻⁴ or less.

### Evaluation of Volume Mean Particle Diameter

The particle size distribution of the powder of the ion conductive solid including the oxide, obtained by ball mill treatment (planetary mill P-7 manufactured by Fritsch GmbH) after the primary baking, was measured using a laser diffraction/scattering-type particle size distribution measurement apparatus LA-960V2 manufactured by HORIBA, Ltd. A refractive index was set at 1.8, and ethanol was used as a measurement solvent. The concentration of the sample was adjusted so that a transmittance was 90 to 70%. The volume mean particle diameter was calculated from an obtained frequency distribution.

### Results

The stoichiometric amounts (values of a, b, c, and d in the general formula: Li_{6+a-c-2d}X_{1-a-b-c-d}M1ₐM2_{b}M3_{c}M4_{d}B₃O₉) of the raw materials, volume mean particle diameters, and ionic conductivities in the case of producing each of the sintered bodies of the ion conductive solids including the oxides of Examples 1 to 47, 101 to 144, 201 to 242 and 301 to 342, and Comparative Examples 1 to 3 are listed in Table 1, Table 2, Table 3, and Table 4.

As a result of the composition analysis described above, all the sintered bodies of the ion conductive solids including the oxides of Examples 1 to 47, 101 to 144, 201 to 242 and 301 to 342, and Comparative Examples 1 to 3 were confirmed to have the compositions in the stoichiometric amounts of the raw materials set forth in Table 1, Table 2, Table 3, and Table 4. Moreover, the sintered bodies of the ion conductive solids including the oxides of Examples 1 to 47, 101 to 144, 201 to 242 and 301 to 342 were ion conductive solids indicating the high ionic conductivities even if the baking was performed at a temperature of less than 700° C.

TABLE 1

| | | | | | | | | | Mean | Ionic |
|---|---|---|---|---|---|---|---|---|---|---|
| | Li_{6+a-c-2d}Lu_{1-a-b-c-d}M1ₐM2_{b}M3_{c}M4_{d}B₃O₉ | | | | | | | | diameter | conductivity |
| | M1 | M2 | M3 | M4 | a | b | c | d | [μm] | [S/cm] |
| Comparative | — | — | — | Nb | 0 | 0 | 0 | 0.400 | 10.1 | 5.65 × 10⁻¹⁰ |
| Example 1 | | | | | | | | | | |
| Comparative | — | — | Ce | — | 0 | 0 | 0.300 | 0 | 21.3 | 2.66 × 10⁻⁸ |
| Example 2 | | | | | | | | | | |
| Comparative | — | — | Zr:Ce = 1:1 | Nb | 0 | 0 | 0.200 | 0.100 | 15. | 8.73 × 10⁻ [symbol] |
| Example 3 | | | | | | | | | | |
| Example 1 | — | — | — | Nb | 0 | 0 | 0 | 0.400 | 10.9 | 1.58 × 10⁻⁷ |
| Example 2 | — | — | Ce | — | 0 | 0 | 0.300 | 0 | 13.1 | 4.16 × 10⁻⁷ |
| Example 3 | — | — | Zr:Ce = 1:1 | Nb | 0 | 0 | 0.200 | 0.100 | 14.8 | 5.07 × 10⁻⁷ |
| Example 4 | — | — | — | — | 0 | 0 | 0 | 0 | 12.0 | 2.66 × 10⁻⁷ |
| Example 5 | — | — | Hf | — | 0 | 0 | 0.100 | 0 | 7.7 | 2.32 × 10⁻⁶ |
| Example 6 | — | — | Zr:Ce = 4:1 | — | 0 | 0 | 0.125 | 0 | 8.1 | 3.06 × 10⁻ [symbol] |
| Example 7 | — | — | Zr | Nb | 0 | 0 | 0.100 | 0.025 | 0.4 | 2.58 × 10⁻ [symbol] |
| Example 8 | — | In | Sn | — | 0 | 0.500 | 0.400 | 0 | 9.3 | 1.97 × 10⁻⁷ |
| Example 9 | — | In | Hf | — | 0 | 0.300 | 0.100 | 0 | 8.6 | 6.11 × 10⁻ [symbol] |
| Example 10 | — | Fe | Ti | — | 0 | 0.100 | 0.800 | 0 | 10.1 | 1.37 × 10⁻ [symbol] |
| Example 11 | — | Fe | Zr:Hf = 4:1 | — | 0 | 0.400 | 0.100 | 0 | 9.9 | 3.08 × 10⁻ [symbol] |
| Example 12 | — | Ho | — | — | 0 | 0.900 | 0 | 0 | 9.5 | 8.33 × 10⁻ [symbol] |
| Example 13 | Mg | — | Ce | — | 0.025 | 0 | 0.025 | 0 | 9.1 | 7.84 × 10⁻⁷ |
| Example 14 | Mg:Ca = 1:1 | La | — | — | 0.100 | 0.800 | 0 | 0 | 9.1 | 5.64 × 10⁻⁸ |
| Example 15 | Mn | La | — | — | 0.800 | 0.100 | 0 | 0 | 8.8 | 3.07 × 10⁻⁸ |
| Example 16 | Mn | Tb | — | — | 0.050 | 0.100 | 0 | 0 | 21.0 | 1.22 × 10⁻⁷ |
| Example 17 | Mn | Tm | — | — | 0.050 | 0.100 | 0 | 0 | 15.6 | 1.81 × 10⁻⁷ |
| Example 18 | — | — | Sn | Nb | 0 | 0 | 0.100 | 0.400 | 13.7 | 9.67 × 10⁻⁸ |
| Example 19 | — | In | — | Nb:Ta = 1:1 | 0 | 0.300 | 0 | 0.100 | 9.0 | 4.17 × 10⁻ [symbol] |
| Example 20 | — | Pr | — | — | 0 | 0.500 | 0 | 0 | 8.1 | 4.32 × 10⁻⁸ |
| Example 21 | — | Pr:La = 1:1 | — | Nb | 0 | 0.100 | 0 | 0.800 | 10.6 | 7.82 × 10⁻ [symbol] |
| Example 22 | — | Sm | Hf | Ta | 0 | 0.500 | 0.050 | 0.050 | 7.8 | 2.04 × 10⁻⁷ |
| Example 23 | Zn | Nd:Sm = 1:1 | — | — | 0.100 | 0.200 | 0 | 0 | 8.4 | 3.92 × 10⁻⁷ |
| Example 24 | — | Nd | Zr | — | 0 | 0.100 | 0.100 | 0 | 8.8 | 2.08 × 10⁻ [symbol] |
| Example 25 | — | Eu | — | — | 0 | 0.100 | 0 | 0 | 12.4 | 3.12 × 10⁻⁷ |
| Example 26 | Ni | Eu | — | — | 0.100 | 0.100 | 0 | 0 | 22.9 | 3.88 × 10⁻⁷ |
| Example 27 | — | Eu | Zr:Hf = 4:1 | — | 0 | 0.100 | 0.100 | 0 | 13.6 | 8.61 × 10⁻ [symbol] |
| Example 28 | Ca | Gd:Dy = 1:1 | — | — | 0.100 | 0.200 | 0 | 0 | 11.1 | 3.20 × 10⁻⁷ |
| Example 29 | — | Gd | Zr | — | 0 | 0.100 | 0.100 | 0 | 7.7 | 1.07 × 10⁻ [symbol] |
| Example 30 | — | Dy | Ti:Sn = 1:1 | — | 0 | 0.100 | 0.100 | 0 | 12.4 | 4.03 × 10⁻ [symbol] |
| Example 31 | — | Dy | — | — | 0 | 0.100 | 0 | 0 | 16.1 | 7.92 × 10⁻ [symbol] |
| Example 32 | Ba:Ni = 1:1 | Tb | — | — | 0.100 | 0.100 | 0 | 0 | 22.8 | 5.21 × 10⁻⁷ |
| Example 33 | Ba | Tb:Ho = 1:1 | — | — | 0.100 | 0.200 | 0 | 0 | 11.2 | 1.86 × 10⁻⁷ |
| Example 34 | — | — | Hf | Ta | 0 | 0.100 | 0.050 | 0.050 | 9.0 | 6.74 × 10⁻⁷ |
| Example 35 | Sr | Er:Tm = 1:1 | — | — | 0.100 | 0.200 | 0 | 0 | 11.6 | 2.33 × 10⁻⁷ |
| Example 36 | — | Er | Ti | — | 0 | 0.100 | 0.100 | 0 | 13.0 | 3.60 × 10⁻⁷ |
| Example 37 | Ni | Er | Sn | — | 0.100 | 0.100 | 0.100 | 0 | 9.4 | 1.61 × 10⁻⁷ |
| Example 38 | — | Tm | — | Nb | 0 | 0.100 | 0 | 0.100 | 8.0 | 1.70 × 10⁻⁷ |
| Example 39 | — | Tm | Zr | Ta | 0 | 0.100 | 0.100 | 0.100 | 11.7 | 5.94 × 10⁻ [symbol] |
| Example 40 | Mg | Gd | Ce | — | 0.100 | 0.100 | 0.100 | 0 | 10.6 | 4.10 × 10⁻⁷ |
| Example 41 | — | Gd | — | Nb | 0 | 0.010 | 0 | 0.100 | 8.4 | 3.77 × 10⁻⁷ |
| Example 42 | — | Gd | — | Ta | 0 | 0.100 | 0 | 0.800 | 11.4 | 5.62 × 10⁻ [symbol] |
| Example 43 | — | Sc | — | — | 0 | 0.100 | 0 | 0 | 8.3 | 1.55 × 10⁻ [symbol] |
| Example 44 | Mn | Tb | — | — | 0.050 | 0.100 | 0 | 0 | 9.9 | 1.89 × 10⁻⁷ |
| Example 45 | Ni | Eu | — | — | 0.100 | 0.100 | 0 | 0 | 15.0 | 4.10 × 10⁻⁷ |
| Example 46 | Ba:Ni = 1:1 | Tb | — | — | 0.100 | 0.100 | 0 | 0 | 13.9 | 5.54 × 10⁻⁷ |
| Example 47 | Ba:Ni = 1:1 | Tb | — | — | 0.100 | 0.100 | 0 | 0 | 41.3 | 2.07 × 10⁻⁷ |

[symbol]

indicates data missing or illegible when filed

In the Table, Comparative Examples 1 to 3 each corresponded to the oxide represented by the general formula: Li_{6+a-c-2d}Y_{1-a-b-c-d}M1ₐM2_{b}M3_{c}M4_{d}B₃O₉.

TABLE 2

| | | | | | | | | | Mean | Ionic |
|---|---|---|---|---|---|---|---|---|---|---|
| | Li_{6+a-c-2d}Ho_{1-a-b-c-d}MTₐM2_{b}M3_{c}M4_{d}B₃O [symbol] | | | | | | | | diameter | conductivity |
| | M1 | M2 | M3 | M4 | a | b | c | d | [μm] | [S/cm] |
| Comparative | — | — | — | Nb | 0 | 0 | 0 | 0.400 | 10.1 | 5.65 × 10⁻¹⁰ |
| Example 1 | | | | | | | | | | |
| Comparative | — | — | Ce | — | 0 | 0 | 0.300 | 0 | 21.3 | 2.66 × 10⁻⁸ |
| Example 2 | | | | | | | | | | |
| Comparative | — | — | Zr.Ce = 1:1 | Nb | 0 | 0 | 0.200 | 0.100 | 15.1 | 8.73 × 10⁻⁸ |
| Example 3 | | | | | | | | | | |
| Example 101 | — | — | — | Nb | 0 | 0 | 0 | 0.400 | 8.5 | 1.33 × 10⁻⁷ |
| Example 102 | — | — | Ce | — | 0 | 0 | 0.300 | 0 | 17.7 | 4.57 × 10⁻⁷ |
| Example 103 | — | — | Zr:Ce = 1:1 | Nb | 0 | 0 | 0.200 | 0.100 | 11.9 | 5.14 × 10⁻⁷ |
| Example 104 | — | — | — | — | 0 | 0 | 0 | 0 | 13.2 | 2.39 × 10⁻⁷ |
| Example 105 | — | — | Hf | — | 0 | 0 | 0.100 | 0 | 8.6 | 2.28 × 10⁻⁶ |
| Example 106 | — | — | Zr:Ce = 4:1 | — | 0 | 0 | 0.125 | 0 | 6.8 | 1.78 × 10⁻⁵ |
| Example 107 | — | — | Zr | Nb | 0 | 0 | 0.100 | 0.025 | 0.7 | 1.56 × 10⁻⁵ |
| Example 108 | — | In | Sn | — | 0 | 0.500 | 0.400 | 0 | 9.1 | 2.11 × 10⁻⁷ |
| Example 109 | — | In | Hf | — | 0 | 0.300 | 0.100 | 0 | 8.0 | 5.22 × 10⁻⁶ |
| Example 110 | — | Fe | Ti | — | 0 | 0.100 | 0.800 | 0 | 13.4 | 1.77 × 10⁻⁸ |
| Example 111 | — | Fe | Zr:Hf = 4:1 | — | 0 | 0.400 | 0.100 | 0 | 11.2 | 2.61 × 10⁻⁶ |
| Example 112 | Mg | — | Ce | — | 0.025 | 0 | 0.025 | 0 | 8.5 | 7.63 × 10⁻⁷ |
| Example 113 | Mg:Ca = 1:1 | La | — | — | 0.100 | 0.800 | 0 | 0 | 10.2 | 9.79 × 10⁻⁸ |
| Example 114 | Mn | Lu | — | — | 0.800 | 0.100 | 0 | 0 | 9.6 | 6.42 × 10⁻⁸ |
| Example 115 | Mn | Tb | — | — | 0.050 | 0.100 | 0 | 0 | 21.7 | 3.02 × 10⁻⁷ |
| Example 116 | Ba | Tm | — | — | 0.050 | 0.100 | 0 | 0 | 12.0 | 1.87 × 10⁻⁷ |
| Example 117 | — | — | Sn | Nb | 0 | 0 | 0.100 | 0.400 | 12.3 | 7.88 × 10⁻ [symbol] |
| Example 118 | — | In | — | Nb:Ta = 1:1 | 0 | 0.300 | 0 | 0.100 | 10.5 | 4.13 × 10⁻ [symbol] |
| Example 119 | — | Pr | — | — | 0 | 0.500 | 0 | 0 | 9.4 | 5.39 × 10⁻ [symbol] |
| Example 120 | — | Pr:La = 1:1 | — | Nb | 0 | 0.100 | 0 | 0.800 | 8.1 | 7.71 × 10⁻⁹ |
| Example 121 | — | Sm | Hf | Ta | 0 | 0.500 | 0.050 | 0.050 | 8.1 | 2.40 × 10⁻⁷ |
| Example 122 | Zn | Nd:Sm = 1:1 | — | — | 0.100 | 0.200 | 0 | 0 | 8.9 | 5.06 × 10⁻⁷ |
| Example 123 | — | Nd | Zr | — | 0 | 0.100 | 0.100 | 0 | 9.3 | 2.11 × 10⁻ [symbol] |
| Example 124 | — | Eu | — | — | 0 | 0.100 | 0 | 0 | 10.1 | 3.30 × 10⁻⁷ |
| Example 125 | Ni | Eu | — | — | 0.100 | 0.100 | 0 | 0 | 21.4 | 4.28 × 10⁻⁷ |
| Example 126 | — | Eu | Zr:Hf = 4:1 | — | 0 | 0.100 | 0.100 | 0 | 15.3 | 8.55 × 10⁻ [symbol] |
| Example 127 | Ca | Gd:Dy = 1:1 | — | — | 0.100 | 0.200 | 0 | 0 | 14.8 | 4.07 × 10⁻⁷ |
| Example 128 | — | Gd | Zr | — | 0 | 0.100 | 0.100 | 0 | 9.0 | 1.88 × 10⁻⁵ |
| Example 129 | — | Dy | Ti:Sn = 1:1 | — | 0 | 0.100 | 0.100 | 0 | 16.1 | 4.64 × 10⁻ [symbol] |
| Example 130 | — | Dy | — | — | 0 | 0.100 | 0 | 0 | 14.2 | 7.06 × 10⁻⁸ |
| Example 131 | Ba:Ni = 1:1 | Tb | — | — | 0.100 | 0.100 | 0 | 0 | 24.5 | 5.44 × 10⁻⁷ |
| Example 132 | — | Tb | Hf | Ta | 0 | 0.100 | 0.050 | 0.050 | 9.9 | 6.40 × 10⁻⁷ |
| Example 133 | Sr | Er:Tm = 1:1 | — | — | 0.100 | 0.200 | 0 | 0 | 10.6 | 2.09 × 10⁻⁷ |
| Example 134 | — | Er | Ti | — | 0 | 0.100 | 0.100 | 0 | 12.2 | 4.59 × 10⁻⁷ |
| Example 135 | Ni | Er | Sn | — | 0.100 | 0.100 | 0.100 | 0 | 8.3 | 1.78 × 10⁻⁷ |
| Example 136 | — | Tm | — | Nb | 0 | 0.100 | 0 | 0.100 | 9.7 | 2.15 × 10⁻⁷ |
| Example 137 | — | Tm | Zr | Ta | 0 | 0.100 | 0.100 | 0.100 | 16.0 | 5.96 × 10⁻ [symbol] |
| Example 138 | Mg | Gd | Ce | — | 0.100 | 0.100 | 0.100 | 0 | 10.1 | 4.38 × 10⁻⁷ |
| Example 139 | — | Gd | — | Nb | 0 | 0.010 | 0 | 0.100 | 9.5 | 3.50 × 10⁻⁷ |
| Example 140 | — | Gd | — | Ta | 0 | 0.100 | 0 | 0.800 | 12.7 | 5.71 × 10⁻⁹ |
| Example 141 | — | Sc | — | — | 0 | 0.100 | 0 | 0 | 10.4 | 7.33 × 10⁻⁹ |
| Example 142 | Mn | Tb | — | — | 0.050 | 0.100 | 0 | 0 | 9.7 | 4.56 × 10⁻⁷ |
| Example 143 | Ni | Eu | — | — | 0.100 | 0.100 | 0 | 0 | 12.3 | 5.32 × 10⁻⁷ |
| Example 144 | Ba:Ni = 1:1 | Tb | — | — | 0.100 | 0.100 | 0 | 0 | 14.2 | 6.09 × 10⁻⁷ |

[symbol]

indicates data missing or illegible when filed

In the Table, Comparative Examples 1 to 3 each corresponded to the oxide represented by general formula: Li_{6+a-c-2d}Y_{1-a-b-c-d}M1ₐM2_{b}M3_{c}M4_{d}B₃O₉.

TABLE 3

| | | | | | | | | | Mean | Ionic |
|---|---|---|---|---|---|---|---|---|---|---|
| | Li_{6+a-c-2d}Er_{1-a-b-c-d}M1ₐM2_{b}M3_{c}M4_{d}B₃O₉ | | | | | | | | diameter | conductivity |
| | M1 | M2 | M3 | M4 | a | b | c | d | [μm] | [S/cm] |
| Comparative | — | — | — | Nb | 0 | 0 | 0 | 0.400 | 10.1 | 5.65 × 10⁻¹⁰ |
| Example 1 | | | | | | | | | | |
| Comparative | — | — | Ce | — | 0 | 0 | 0.300 | 0 | 21.3 | 2.66 × 10⁻ [symbol] |
| Example 2 | | | | | | | | | | |
| Comparative | — | — | Zr:Ce = 1:1 | Nb | 0 | 0 | 0.200 | 0.100 | 15.1 | 8.73 × 10⁻ [symbol] |
| Example 3 | | | | | | | | | | |
| Example 201 | — | — | — | Nb | 0 | 0 | 0 | 0.400 | 13.3 | 1.66 × 10⁻⁷ |
| Example 202 | — | — | Ce | — | 0 | 0 | 0.300 | 0 | 10.5 | 4.01 × 10⁻⁷ |
| Example 203 | — | — | Zr:Ce = 1:1 | Nb | 0 | 0 | 0.200 | 0.100 | 17.2 | 5.68 × 10⁻⁷ |
| Example 204 | — | — | — | — | 0 | 0 | 0 | 0 | 9.4 | 2.45 × 10⁻⁷ |
| Example 205 | — | — | Hf | — | 0 | 0 | 0.100 | 0 | 10.1 | 2.02 × 10⁻⁸ |
| Example 206 | — | — | Zr:Ce = 4:1 | — | 0 | 0 | 0.125 | 0 | 5.5 | 2.03 × 10⁻ [symbol] |
| Example 207 | — | — | Zr | Nb | 0 | 0 | 0.100 | 0.025 | 2.8 | 2.01 × 10⁻ [symbol] |
| Example 208 | — | In | Sn | — | 0 | 0.500 | 0.400 | 0 | 6.7 | 2.77 × 10⁻⁷ |
| Example 209 | — | In | Hf | — | 0 | 0.300 | 0.100 | 0 | 11.0 | 6.28 × 10⁻ [symbol] |
| Example 210 | — | Fe | Ti | — | 0 | 0.100 | 0.800 | 0 | 7.5 | 1.31 × 10⁻⁸ |
| Example 211 | — | Fe | Zr:Hf = 4:1 | — | 0 | 0.400 | 0.100 | 0 | 12.3 | 1.59 × 10⁻ [symbol] |
| Example 212 | Mg | — | Ce | — | 0.025 | 0 | 0.025 | 0 | 6.5 | 5.33 × 10⁻⁷ |
| Example 213 | Mg:Ca = 1:1 | La | — | — | 0.100 | 0.800 | 0 | 0 | 10.4 | 4.15 × 10⁻⁸ |
| Example 214 | Mn | Lu | — | — | 0.800 | 0.100 | 0 | 0 | 5.1 | 7.96 × 10⁻ [symbol] |
| Example 215 | Mn | Tb | — | — | 0.050 | 0.100 | 0 | 0 | 23.4 | 1.44 × 10⁻⁷ |
| Example 216 | Mn | Tm | — | — | 0.050 | 0.100 | 0 | 0 | 13.0 | 1.82 × 10⁻⁷ |
| Example 217 | — | — | Sn | Nb | 0 | 0 | 0.100 | 0.400 | 16.1 | 6.93 × 10⁻⁸ |
| Example 218 | — | In | — | Nb:Ta = 1:1 | 0 | 0.300 | 0 | 0.100 | 6.4 | 4.54 × 10⁻ [symbol] |
| Example 219 | — | Pr | — | — | 0 | 0.500 | 0 | 0 | 10.5 | 6.22 × 10⁻ [symbol] |
| Example 220 | — | Pr:La = 1:1 | — | Nb | 0 | 0.100 | 0 | 0.800 | 7.1 | 6.43 × 10⁻⁹ |
| Example 221 | — | Sm | Hf | Ta | 0 | 0.500 | 0.050 | 0.050 | 10.2 | 3.26 × 10⁻⁷ |
| Example 222 | Zn | Nd:Sm = 1:1 | — | — | 0.100 | 0.200 | 0 | 0 | 5.8 | 4.20 × 10⁻⁷ |
| Example 223 | — | Nd | Zr | — | 0 | 0.100 | 0.100 | 0 | 11.2 | 2.30 × 10⁻ [symbol] |
| Example 224 | — | Eu | — | — | 0 | 0.100 | 0 | 0 | 9.8 | 2.77 × 10⁻⁷ |
| Example 225 | Ni | Eu | — | — | 0.100 | 0.100 | 0 | 0 | 25.3 | 3.10 × 10⁻⁷ |
| Example 226 | — | Eu | Zr:Hf = 4:1 | — | 0 | 0.100 | 0.100 | 0 | 11.0 | 7.98 × 10⁻ [symbol] |
| Example 227 | Ca | Gd:Dy = 1:1 | — | — | 0.100 | 0.200 | 0 | 0 | 13.5 | 2.05 × 10⁻⁷ |
| Example 228 | — | Gd | Zr | — | 0 | 0.100 | 0.100 | 0 | 5.1 | 8.81 × 10⁻⁸ |
| Example 229 | — | Dy | Ti:Sn = 1:1 | — | 0 | 0.100 | 0.100 | 0 | 14.8 | 2.67 × 10⁻ [symbol] |
| Example 230 | — | Dy | | — | 0 | 0.100 | 0 | 0 | 13.5 | 7.84 × 10⁻ [symbol] |
| Example 231 | Ba:Ni = 1:1 | Tb | — | — | 0.100 | 0.100 | 0 | 0 | 25.2 | 5.10 × 10⁻⁷ |
| Example 232 | Sr | Tb:Ho = 1:1 | — | — | 0.100 | 0.200 | 0 | 0 | 8.6 | 2.05 × 10⁻⁷ |
| Example 233 | — | Tb | Hf | Ta | 0 | 0.100 | 0.050 | 0.050 | 11.4 | 7.33 × 10⁻⁷ |
| Example 234 | — | Tm | — | Nb | 0 | 0.100 | 0 | 0.100 | 10.4 | 1.87 × 10⁻⁷ |
| Example 235 | — | Tm | Zr | Ta | 0 | 0.100 | 0.100 | 0.100 | 9.1 | 4.65 × 10⁻ [symbol] |
| Example 236 | Mg | Gd | Ce | — | 0.100 | 0.100 | 0.100 | 0 | 13.0 | 4.22 × 10⁻⁷ |
| Example 237 | — | Gd | — | Nb | 0 | 0.010 | 0 | 0.100 | 5.8 | 1.23 × 10⁻⁷ |
| Example 238 | — | Gd | — | Ta | 0 | 0.100 | 0 | 0.800 | 13.8 | 4.74 × 10⁻⁹ |
| Example 239 | — | Sc | — | — | 0 | 0.100 | 0 | 0 | 10.2 | 8.56 × 10⁻⁹ |
| Example 240 | Mn | Tb | — | — | 0.050 | 0.100 | 0 | 0 | 7.3 | 2.31 × 10⁻⁷ |
| Example 241 | Ni | Eu | — | — | 0.100 | 0.100 | 0 | 0 | 17.4 | 3.79 × 10⁻⁷ |
| Example 242 | Ba:Ni = 1:1 | Tb | — | — | 0.100 | 0.100 | 0 | 0 | 11.3 | 5.88 × 10⁻⁷ |

[symbol]

indicates data missing or illegible when filed

In the Table, Comparative Examples 1 to 3 each corresponded to the oxide represented by general formula: Li_{6+a-c-2d}Y_{1-a-b-c-d}M1ₐM2_{b}M3_{c}M4_{d}B₃O₉.

TABLE 4

| | | | | | | | | | Mean | Ionic |
|---|---|---|---|---|---|---|---|---|---|---|
| | Li_{6+a-c-2d}Tm_{1-a-b-c-d}M1ₐM2_{b}M3_{c}M4_{d}B₃O₉ | | | | | | | | diameter | conductivity |
| | M1 | M2 | M3 | M4 | a | b | c | d | [μm] | [S/cm] |
| Comparative | — | — | — | Nb | 0 | 0 | 0 | 0.400 | 10.1 | 5.65 × 10⁻¹⁰ |
| Example 1 | | | | | | | | | | |
| Comparative | — | — | Ce | — | 0 | 0 | 0.300 | 0 | 21.3 | 2.66 × 10⁻⁸ |
| Example 2 | | | | | | | | | | |
| Comparative | — | — | ZrCe = 1:1 | Nb | 0 | 0 | 0.200 | 0.100 | 15.1 | 8.73 × 10⁻⁸ |
| Example 3 | | | | | | | | | | |
| Example 301 | — | — | — | Nb | 0 | 0 | 0 | 0.400 | 14.5 | 1.33 × 10⁻⁷ |
| Example 302 | — | — | Ce | — | 0 | 0 | 0.300 | 0 | 9.2 | 1.06 × 10⁻⁷ |
| Example 303 | — | — | Zr.Ce = 1:1 | Nb | 0 | 0 | 0.200 | 0.100 | 18.4 | 8.12 × 10⁻⁷ |
| Example 304 | — | — | — | — | 0 | 0 | 0 | 0 | 8.1 | 2.20 × 10⁻⁷ |
| Example 305 | — | — | Hf | — | 0 | 0 | 0.100 | 0 | 11.3 | 1.95 × 10⁻ [symbol] |
| Example 306 | — | — | Zr:Ce = 4:1 | — | 0 | 0 | 0.125 | 0 | 7.3 | 2.32 × 10⁻ [symbol] |
| Example 307 | — | — | Zr | Nb | 0 | 0 | 0.100 | 0.025 | 9.9 | 2.18 × 10⁻ [symbol] |
| Example 308 | — | In | Sn | — | 0 | 0.500 | 0.400 | 0 | 6.8 | 1.42 × 10⁻⁷ |
| Example 309 | — | In | Hf | — | 0 | 0.300 | 0.100 | 0 | 12.2 | 7.08 × 10⁻ [symbol] |
| Example 310 | — | Fe | Ti | — | 0 | 0.100 | 0.800 | 0 | 6.2 | 1.40 × 10⁻⁸ |
| Example 311 | — | Fe | Zr:Hf = 4:1 | — | 0 | 0.400 | 0.100 | 0 | 13.5 | 1.69 × 10⁻ [symbol] |
| Example 312 | Mg | — | Ce | — | 0.025 | 0 | 0.025 | 0 | 7.6 | 6.82 × 10⁻⁷ |
| Example 313 | Mg:Ca = 1:1 | La | — | — | 0.100 | 0.800 | 0 | 0 | 11.6 | 8.91 × 10⁻⁸ |
| Example 314 | Mn | Lu | — | — | 0.800 | 0.100 | 0 | 0 | 9.5 | 5.31 × 10⁻⁸ |
| Example 315 | Mn | Tb | — | — | 0.050 | 0.100 | 0 | 0 | 24.6 | 3.03 × 10⁻⁷ |
| Example 316 | — | — | Sn | Nb | 0 | 0 | 0.100 | 0.400 | 17.3 | 9.32 × 10⁻⁸ |
| Example 317 | — | In | — | Nb:Ta = 1:1 | 0 | 0.300 | 0 | 0.100 | 8.2 | 2.56 × 10⁻ [symbol] |
| Example 318 | — | Pr | — | — | 0 | 0.500 | 0 | 0 | 11.7 | 4.70 × 10⁻⁸ |
| Example 319 | — | Pr:La = 1:1 | — | Nb | 0 | 0.100 | 0 | 0.800 | 7.7 | 8.22 × 10⁻ [symbol] |
| Example 320 | — | Sm | Hf | Ta | 0 | 0.500 | 0.050 | 0.050 | 11.4 | 2.74 × 10⁻⁷ |
| Example 321 | Zn | Nd:Sm = 1:1 | — | — | 0.100 | 0.200 | 0 | 0 | 9.6 | 4.69 × 10⁻⁷ |
| Example 322 | — | Nd | Zr | — | 0 | 0.100 | 0.100 | 0 | 12.4 | 2.18 × 10⁻ [symbol] |
| Example 323 | — | Eu | — | — | 0 | 0.100 | 0 | 0 | 8.5 | 3.26 × 10⁻⁷ |
| Example 324 | Ni | Eu | — | — | 0.100 | 0.100 | 0 | 0 | 26.5 | 4.05 × 10⁻⁷ |
| Example 325 | — | Eu | Zr:Hf = 4:1 | — | 0 | 0.100 | 0.100 | 0 | 9.7 | 8.83 × 10⁻ [symbol] |
| Example 326 | Ca | Gd:Dy = 1:1 | — | — | 0.100 | 0.200 | 0 | 0 | 14.7 | 1.88 × 10⁻⁷ |
| Example 327 | — | Gd | Zr | — | 0 | 0.100 | 0.100 | 0 | 7.2 | 8.96 × 10⁻ [symbol] |
| Example 328 | — | Dy | Ti:Sn = 1:1 | — | 0 | 0.100 | 0.100 | 0 | 16.0 | 3.67 × 10⁻ [symbol] |
| Example 329 | — | Dy | — | — | 0 | 0.100 | 0 | 0 | 12.2 | 8.21 × 10⁻⁸ |
| Example 330 | Ba:Ni = 1:1 | Tb | — | — | 0.100 | 0.100 | 0 | 0 | 26.4 | 5.07 × 10⁻⁷ |
| Example 331 | Ba | Tb:Ho = 1:1 | — | — | 0.100 | 0.200 | 0 | 0 | 7.3 | 1.35 × 10⁻⁷ |
| Example 332 | — | Tb | Hf | Ta | 0 | 0.100 | 0.050 | 0.050 | 12.6 | 5.84 × 10⁻⁷ |
| Example 333 | Sr | Er:Ho = 1:1 | — | — | 0.100 | 0.200 | 0 | 0 | 7.7 | 2.12 × 10⁻⁷ |
| Example 334 | — | Er | Ti | — | 0 | 0.100 | 0.100 | 0 | 16.6 | 3.40 × 10⁻⁷ |
| Example 335 | Ni | Er | Sn | — | 0.100 | 0.100 | 0.100 | 0 | 10.3 | 2.06 × 10⁻⁷ |
| Example 336 | Mg | Gd | Ce | — | 0.100 | 0.100 | 0.100 | 0 | 14.2 | 4.66 × 10⁻⁷ |
| Example 337 | — | Gd | — | Nb | 0 | 0.010 | 0 | 0.100 | 10.7 | 3.13 × 10⁻⁷ |
| Example 338 | — | Gd | — | Ta | 0 | 0.100 | 0 | 0.800 | 15.0 | 4.25 × 10⁻ [symbol] |
| Example 339 | — | Sc | — | — | 0 | 0.100 | 0 | 0 | 11.0 | 8.84 × 10⁻ [symbol] |
| Example 340 | Mn | Tb | — | — | 0.050 | 0.100 | 0 | 0 | 11.1 | 3.79 × 10⁻⁷ |
| Example 341 | N | Eu | — | — | 0.100 | 0.100 | 0 | 0 | 18.6 | 4.93 × 10⁻⁷ |
| Example 342 | Ba:Ni = 1:1 | Tb | — | — | 0.100 | 0.100 | 0 | 0 | 10.0 | 3.40 × 10⁻⁷ |

[symbol]

indicates data missing or illegible when filed

In the Table, Comparative Examples 1 to 3 each corresponded to the oxide represented by general formula: Li_{6+a-c-2d}Y_{1-a-b-c-d}M1ₐM2_{b}M3_{c}M4_{d}B₃O₉.

Table 1, Table 2, Table 3, and Table 4 demonstrate the results in which the ion conductivities of the ion conductive solids produced in Examples 1, 101, 201 and 301 were improved in comparison with that in Comparative Example 1, and the results in which higher ionic conductivities were obtained by substitution of Y with at least one selected from the group consisting of Lu, Ho, Er, and Tm. It can be seen that higher ionic conductivities are obtained by substituting Y in the composition disclosed in the related art, with at least one selected from the group consisting of Lu, Ho, Er, and Tm being metal elements having small ionic radii.

Table 1 demonstrates the result in which the ion conductivities of the ion conductive solids produced in Examples 1 to 3 were respectively improved in comparison with those in Comparative Examples 1 to 3, and the results in which higher ionic conductivities were obtained by substitution of Y with Lu. It can be seen that a higher ionic conductivity is obtained by substituting Y in the composition disclosed in the related art, with Lu having a small ionic radius.

There are also demonstrated the results in which the ion conductivities of the ion conductive solids produced in Examples 44 to 46 were respectively improved in comparison with those in Examples 16, 26, and 32. Because the compositions of substituted elements are different from those disclosed in the related art, the influences of differences between melting points and the like on densities after baking may result in the different appropriate ranges of particle diameters.

Table 2 demonstrates the result in which the ion conductivities of the ion conductive solids produced in Examples 101 to 103 were respectively improved in comparison with those in Comparative Examples 1 to 3, and the results in which higher ionic conductivities were obtained by substitution of Y with Ho. It can be seen that a higher ionic conductivity is obtained by substituting Y in the composition disclosed in the related art, with Ho having a small ionic radius.

There are also demonstrated the results in which the ion conductivities of the ion conductive solids produced in Examples 142 to 144 were respectively improved in comparison with those in Examples 115, 125, and 131. Because the compositions of substituted elements are different from those disclosed in the related art, the influences of differences between melting points and the like on densities after baking may result in the different appropriate ranges of particle diameters.

Table 3 demonstrates the result in which the ion conductivities of the ion conductive solids produced in Examples 201 to 203 were respectively improved in comparison with those in Comparative Examples 1 to 3, and the results in which higher ionic conductivities were obtained by substitution of Y with Er. It can be seen that a higher ionic conductivity is obtained by substituting Y in the composition disclosed in the related art, with Er having a small ionic radius.

There are also demonstrated the results in which the ion conductivities of the ion conductive solids produced in Examples 240 to 242 were respectively improved in comparison with those in Examples 215, 225, and 231. Because the compositions of substituted elements are different from those disclosed in the related art, the influences of differences between melting points and the like on densities after baking may result in the different appropriate ranges of particle diameters.

Table 4 demonstrates the result in which the ion conductivities of the ion conductive solids produced in Examples 301 to 303 were respectively improved in comparison with those in Comparative Examples 1 to 3, and the results in which higher ionic conductivities were obtained by substitution of Y with Tm. It can be seen that a higher ionic conductivity is obtained by substituting Y in the composition disclosed in the related art, with Tm having a small ionic radius.

There are also demonstrated the results in which the ion conductivities of the ion conductive solids produced in Examples 340 to 342 were respectively improved in comparison with those in Example 315, 324, and 330. Because the compositions of substituted elements are different from those disclosed in the related art, the influences of differences between melting points and the like on densities after baking may result in the different appropriate ranges of particle diameters.

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

What is claimed is:

1. An ion conductive solid comprising an oxide represented by a general formula: Li_{6+a-c-2d}X_{1-a-b-c-d}M1ₐM2_{b}M3_{c}M4_{d}B₃O₉,
where, in formula, X is at least one metal element selected from a group consisting of Lu, Ho, Er, and Tm,
M1 is at least one metal element selected from a group consisting of Mg, Mn, Zn, Ni, Ca, Sr, and Ba,
M2 is at least one metal element selected from a group consisting of La, Pr, Nd, Sm, Eu, Gd, Tb, Dy, Ho, Er, Tm, Lu, In, Fe, and Sc,
M3 is at least one metal element selected from a group consisting of Zr, Ce, Hf, Sn, and Ti,
M4 is at least one metal element selected from a group consisting of Nb and Ta, and
a is 0.000≤a≤0.800, b is 0.000≤b≤0.900, c is 0.000≤c≤0.800, d is 0.000≤d≤0.800, and a, b, c, and d are real numbers satisfying 0.000≤a+b+c+d<1.000, provided that a case in which X and M2 are the same metal elements is excluded.

2. The ion conductive solid according to claim 1, wherein the 1−a−b−c−d is 0.300≤1−a−b−c−d.

3. The ion conductive solid according to claim 1, wherein the 1−a−b−c−d is 0.500≤1−a−b−c−d.

4. The ion conductive solid according to claim 1, wherein the a is 0.000≤a≤0.400.

5. The ion conductive solid according to claim 1, wherein the b is 0.000≤b≤0.500.

6. The ion conductive solid according to claim 1, wherein the c is 0.000≤c≤0.400.

7. The ion conductive solid according to claim 1, wherein the d is 0.000≤d≤0.400.

8. The ion conductive solid according to claim 1, wherein the ion conductive solid has a volume mean particle diameter of 0.1 μm or more and 28.0 μm or less.

9. An all-solid-state battery comprising at least:
a cathode;
an anode; and
an electrolyte,
wherein at least one selected from a group consisting of the cathode, the anode, and the electrolyte comprises the ion conductive solid according to claim 1.

10. The all-solid-state battery according to claim 9, wherein at least the electrolyte comprises the ion conductive solid.
